(19) United States
(12) Patent Application Publication
(10) Pub. No.: US 2025/0207985 A1
(43) Pub. Date: Jun. 26, 2025

(54) LOAD DETECTING DEVICE AND DETECTING CIRCUIT

(71) Applicant: Panasonic Intellectual Property Management Co., Ltd., Osaka (JP)

(72) Inventor: Masaki TAMARU, Kyoto (JP)

(21) Appl. No.: 19/078,993

(22) Filed: Mar. 13, 2025

Related U.S. Application Data
(63) Continuation of application No. PCT/JP2023/024091, filed on Jun. 28, 2023.

(30) Foreign Application Priority Data
Sep. 27, 2022 (JP) 2022-153505

(51) Int. Cl. G01L 1/14; G01L 5/165

(52) U.S. Cl. CPC G01L 1/146; G01L 1/144; G01L 5/165

(57) ABSTRACT

A load detecting device includes: a load sensor including an element part in which capacitance changes in accordance with a load; and a detecting circuit configured to detect capacitance in the element part. The detecting circuit includes a potential applier configured to apply a predetermined potential to both electrodes of the element part, a measurer configured to measure an electric quantity which changes due to charging or discharging of electric charge with respect to the element part, and a controller. The controller acquires a first value from the electric quantity measured in the first mode in which potentials applied to the both electrodes are different from each other, acquires a second value from the electric quantity measured in a second mode in which potentials applied to the both electrodes are identical, and detects capacitance in the element part, from a difference between the first value and the second value.

### CROSS REFERENCE TO RELATED APPLICATION

This application is a continuation of International Application No. PCT/JP2023/024091 filed on Jun. 28, 2023, entitled “LOAD DETECTING DEVICE AND DETECTING CIRCUIT”, which claims priority under 35 U.S.C. Section 119 of Japanese Patent Application No. 2022-153505 filed on Sep. 27, 2022, entitled “LOAD DETECTING DEVICE AND DETECTING CIRCUIT”. The disclosures of the above applications are incorporated herein by reference.

### BACKGROUND OF THE INVENTION

### Field of the Invention

The present invention relates to a load detecting device that detects a load, based on change in capacitance, and a detecting circuit that detects capacitance from an element part having certain capacitance.

### Description of Related Art

Load sensors are widely used in the fields of industrial apparatuses, robots, vehicles, and the like. In recent years, in accordance with advancement of control technologies by computers and improvement of design, development of electronic apparatuses that use a variety of free-form surfaces such as those in human-form robots and interior equipment of automobiles is in progress. In association therewith, it is required to mount a high performance load sensor to each free-form surface.

Japanese Laid-Open Patent Publication No. 2021-81209 describes a device that detects the capacitance of a capacitance-type sensor. In this device, a voltage is applied to an element part serving as a measurement target via a resistor. Based on change in the voltage in the subsequent stage of the resistor, the capacitance in the element part serving as the measurement target is detected. Specifically, at a predetermined timing in a voltage application period, the voltage value in the subsequent stage of the resistor is measured, and based on this voltage value, the capacitance in the element part serving as the measurement target is calculated. Further, based on the calculated capacitance, the load applied to the element part serving as the measurement target is calculated.

However, in the above method, parasitic capacitance, parasitic inductance, and the like of another element part or wiring influences change in the voltage in the subsequent stage of the resistor. As a result, the calculated capacitance includes an error component, and due to this error component, the detection accuracy of the load decreases.

### SUMMARY OF THE INVENTION

A first aspect of the present invention relates to a load detecting device. The load detecting device according to this aspect includes: a load sensor including an element part in which capacitance changes in accordance with a load; and a detecting circuit configured to detect capacitance in the element part. The detecting circuit includes a potential applier configured to apply a predetermined potential to both electrodes of the element part, a measurer configured to measure an electric quantity which changes due to charging or discharging of electric charge with respect to the element part, and a controller. The controller acquires a first value from the electric quantity measured in the first mode in which potentials applied to the both electrodes are different from each other, acquires a second value from the electric quantity measured in a second mode in which potentials applied to the both electrodes are identical, and detects capacitance in the element part, from a difference between the first value and the second value.

In the load detecting device according to the present aspect, the first value reflects the electric charge amount accumulated in the element part and the unnecessary electric charge amount due to parasitic capacitance, parasitic inductance, and the like, and the second value mainly reflects the unnecessary electric charge amount due to parasitic capacitance, parasitic inductance, and the like. Therefore, when the difference between the first value and the second value is taken, influence of the unnecessary electric charge amount is canceled from the first value, and this difference mainly reflects the electric charge amount accumulated in the element part. Therefore, when the capacitance in the element part is detected from this difference, capacitance in which influence of parasitic capacitance, parasitic inductance, and the like is effectively suppressed can be acquired. Therefore, the detection accuracy of the load applied to the element part can be enhanced.

In addition, for detection of the capacitance, it is not necessary to separately provide a special circuit, and it is sufficient that the potential to be applied to both electrodes of the element part is switched as described above. Therefore, the capacitance in the element part can be accurately detected with a simple configuration.

A second aspect of the present invention relates to a detecting circuit configured to detect, from an element part having certain capacitance, the capacitance. The detecting circuit according to this aspect includes: a potential applier configured to apply a predetermined potential to both electrodes of the element part; a measurer configured to measure an electric quantity which changes due to charging or discharging of electric charge with respect to the element part; and a controller. The controller acquires a first value from the electric quantity measured in a first mode in which potentials applied to the both electrodes are different from each other, acquires a second value from the electric quantity measured in a second mode in which potentials applied to the both electrodes are identical, and detects the capacitance in the element part from a difference between the first value and the second value.

In the detecting circuit according to the present aspect, as in the first aspect above, the capacitance in the element part can be accurately detected.

The effects and the significance of the present invention will be further clarified by the description of the embodiments below. However, the embodiments below are merely examples for implementing the present invention. The present invention is not limited to the description of the embodiments below in any way.

### BRIEF DESCRIPTION OF THE DRAWINGS

FIG. 1A is a perspective view schematically showing a base member and electrically-conductive elastic bodies set on the upper face of the base member according to Embodiment 1;

FIG. 1B is a perspective view schematically showing a state where conductor wires are set on the structure in FIG. 1A according to Embodiment 1;

FIG. 2A is a perspective view schematically showing a state where threads are set on the structure in FIG. 1B according to Embodiment 1;

FIG. 2B is a perspective view schematically showing a state where a base member is set on the structure in FIG. 2A according to Embodiment 1;

FIG. 3A and FIG. 3B each schematically show a cross section of a load sensor according to Embodiment 1;

FIG. 4 is a plan view schematically showing a configuration of the inside of the load sensor according to Embodiment 1;

FIG. 5 is a block diagram showing a configuration of a load detecting device according to Embodiment 1;

FIG. 6 is a circuit diagram showing a configuration of a potential applier according to Embodiment 1;

FIG. 7 is a time chart showing a gate signal outputted from a gate signal generator according to Embodiment 1;

FIG. 8 shows an operation state of the potential applier in a first mode in which different potentials are applied to both electrodes of an element part serving as a measurement target according to Embodiment 1;

FIG. 9 shows an operation state of the potential applier during discharging according to Embodiment 1;

FIG. 10 shows an operation state of the potential applier in a second mode in which the same potential is applied to both electrodes of the element part serving as a measurement target according to Embodiment 1;

FIG. 11 shows an operation state of the potential applier during discharging according to Embodiment 1;

FIG. 12 is a time chart schematically showing currents measured by a current measurer according to Embodiment 1;

FIG. 13 shows an operation state of the potential applier when applying the same potential to both electrodes of the element part serving as the next measurement target according to Embodiment 1;

FIG. 14 is a flowchart showing a capacitance detection process according to Embodiment 1;

FIG. 15 is a graph showing a simulation result of capacitance according to Embodiment 1;

FIG. 16 is a flowchart showing a capacitance detection process according to Modification 1;

FIG. 17 schematically shows an operation state of the potential applier in the second mode in which the same potential is applied to both electrodes of the element part serving as the measurement target according to Modification 1;

FIG. 18 schematically shows an operation state of the potential applier in the first mode in which different potentials are applied to both electrodes of the element part serving as the measurement target according to Modification 1;

FIG. 19 is a circuit diagram showing a configuration of the potential applier according to Modification 2;

FIG. 20 is a circuit diagram showing a configuration of the potential applier and the load sensor according to Modification 3;

FIG. 21 is a block diagram showing a configuration of the load detecting device according to Embodiment 2;

FIG. 22 is a circuit diagram showing a configuration of the potential applier according to Embodiment 2;

FIG. 23 shows an operation state of the potential applier in the second mode in which the same potential is applied to both electrodes of the element part serving as the measurement target according to Embodiment 2;

FIG. 24 shows an operation state of the potential applier during discharging according to Embodiment 2;

FIG. 25 shows an operation state of the potential applier in the first mode in which different potentials are applied to both electrodes of the element part serving as the measurement target according to Embodiment 2; and

FIG. 26 schematically shows change in voltage measured by a voltage measurer according to Embodiment 2.

It is noted that the drawings are solely for description and do not limit the scope of the present invention in any way.

### DETAILED DESCRIPTION

A load detecting device according to the present invention is applicable to a management system or the like that performs processing in accordance with an applied load. Examples of the management system include a stock management system, a driver monitoring system, a coaching management system, a security management system, and a caregiving/nursing management system.

In the stock management system, for example, by a load sensor provided to a stock shelf, the load of a placed commodity is detected, and the kinds of commodities and the number of commodities present on the stock shelf are detected. Accordingly, in a store, a factory, a warehouse, and the like, the commodities can be efficiently managed, and manpower saving can be realized. In addition, by a load sensor provided in a refrigerator, the load of food in the refrigerator is detected, and the kinds of the food and the quantity and amount of the food in the refrigerator are detected. Accordingly, a menu that uses food in a refrigerator can be automatically proposed.

In the driver monitoring system, by a load sensor provided to a steering device, the distribution of a load (e.g., gripping force, grip position, tread force) applied to the steering device by a driver is monitored, for example. In addition, by a load sensor provided to a vehicle-mounted seat, the distribution of a load (e.g., the position of the center of gravity) applied to the vehicle-mounted seat by the driver in a seated state is monitored. Accordingly, the driving state (sleepiness, mental state, and the like) of the driver can be fed back.

In the coaching management system, for example, by a load sensor provided to the bottom of a shoe, the load distribution at a sole is monitored. Accordingly, correction or guidance to an appropriate walking state or running state can be realized.

In the security management system, for example, by a load sensor provided to a floor, the load distribution is detected when a person passes, and the body weight, stride, passing speed, shoe sole pattern, and the like are detected. Accordingly, the person who has passed can be identified by checking these pieces of detection information against data.

In the caregiving/nursing management system, for example, by load sensors provided to bedclothes and a toilet seat, the distributions of loads applied by a human body to the bedclothes and the toilet seat are monitored. Accordingly, at the positions of the bedclothes and the toilet seat, what action the person is going to take is estimated, whereby tumbling or falling can be prevented.

The load detecting device of the embodiments below is applied to a management system as described above, for example. The load detecting device of the embodiments below includes: a load sensor for detecting a load; a detecting circuit combined with the load sensor; and a control circuit that controls the detecting circuit. The load sensor of the embodiments below is a capacitance-type load sensor. Such a load sensor may be referred to as a “capacitance-type pressure-sensitive sensor element”, a “capacitive pressure detection sensor element”, “a pressure-sensitive switch element”, or the like. The embodiments below are examples of embodiments of the present invention, and the present invention is not limited to the embodiments below in any way.

Hereinafter, embodiments of the present invention will be described with reference to the drawings. For convenience, X-, Y-, and Z-axes orthogonal to each other are indicated in the drawings. The Z-axis direction is the height direction of a load sensor 1.

### Embodiment 1

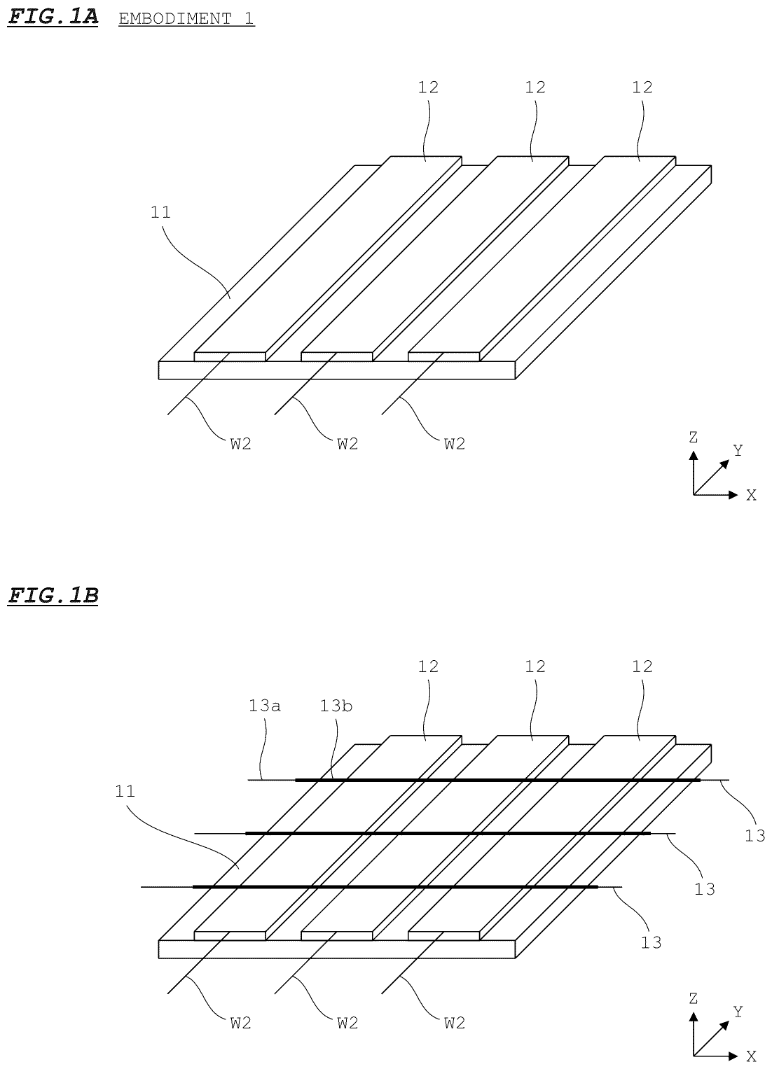

With reference to FIG. 1A to FIG. 4, the load sensor 1 will be described.

FIG. 1A is a perspective view schematically showing a base member 11 and electrically-conductive elastic bodies 12 set on the upper face (the face on the Z-axis positive side) of the base member 11.

The base member 11 is an insulative flat-plate-shaped member having elasticity. The base member 11 has a rectangular shape in a plan view. The thickness of the base member 11 is constant. The thickness of the base member 11 is 0.01 mm to 2 mm, for example. When the thickness of the base member 11 is small, the base member 11 may be referred to as a sheet member or a film member. The base member 11 is formed from a non-electrically-conductive resin material or a non-electrically-conductive rubber material.

The resin material used in the base member 11 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example. The rubber material used in the base member 11 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive elastic bodies 12 are disposed on the upper face (the face on the Z-axis positive side) of the base member 11. In FIG. 1A, three electrically-conductive elastic bodies 12 are disposed on the upper face of the base member 11. The electrically-conductive elastic bodies 12 are each an electrically-conductive member having elasticity. Each electrically-conductive elastic body 12 has a band-like shape that is long in the Y-axis direction. The three electrically-conductive elastic bodies 12 are disposed so as to be arranged with a predetermined interval therebetween in the X-axis direction. At an end portion on the Y-axis negative side of each electrically-conductive elastic body 12, a wiring cable W2 electrically connected to the electrically-conductive elastic body 12 is set.

Each electrically-conductive elastic body 12 is formed on the upper face of the base member 11 by a printing method such as screen printing, gravure printing, flexographic printing, offset printing, or gravure offset printing. With these printing methods, the electrically-conductive elastic body 12 can be formed so as to have a thickness of about 0.001 mm to 0.5 mm on the upper face of the base member 11.

Each electrically-conductive elastic body 12 is formed from a resin material and an electrically-conductive filler dispersed therein, or from a rubber material and an electrically-conductive filler dispersed therein.

Similar to the resin material used in the base member 11 described above, the resin material used in the electrically-conductive elastic body 12 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example.

Similar to the rubber material used in the base member 11 described above, the rubber material used in the electrically-conductive elastic body 12 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive filler used in the electrically-conductive elastic body 12 is a material of at least one type selected from the group consisting of: metal materials such as Au (gold), Ag (silver), Cu (copper), C (carbon), ZnO (zinc oxide), In₂O₃ (indium oxide (III)), and SnO₂ (tin oxide (IV)); electrically-conductive macromolecule materials such as PEDOT:PSS (i.e., a complex composed of poly (3,4-ethylenedioxythiophene) (PEDOT) and polystyrene sulfonate (PSS)); and electrically-conductive fibers such as a metal-coated organic matter fiber and a metal wire (fiber state), for example.

FIG. 1B is a perspective view schematically showing a state where conductor wires 13 are set on the structure in FIG. 1A.

Each conductor wire 13 is a linear-shaped member, and is disposed so as to be superposed on the upper faces of the electrically-conductive elastic bodies 12 shown in FIG. 1A. In the present embodiment, three conductor wires 13 are disposed so as to be superposed on the upper faces of the three electrically-conductive elastic bodies 12. The three conductor wires 13 are disposed so as to be arranged with a predetermined interval therebetween along the longitudinal direction (the Y-axis direction) of the electrically-conductive elastic bodies 12 so as to cross the electrically-conductive elastic bodies 12. Each conductor wire 13 is disposed, extending in the X-axis direction, so as to extend across the three electrically-conductive elastic bodies 12.

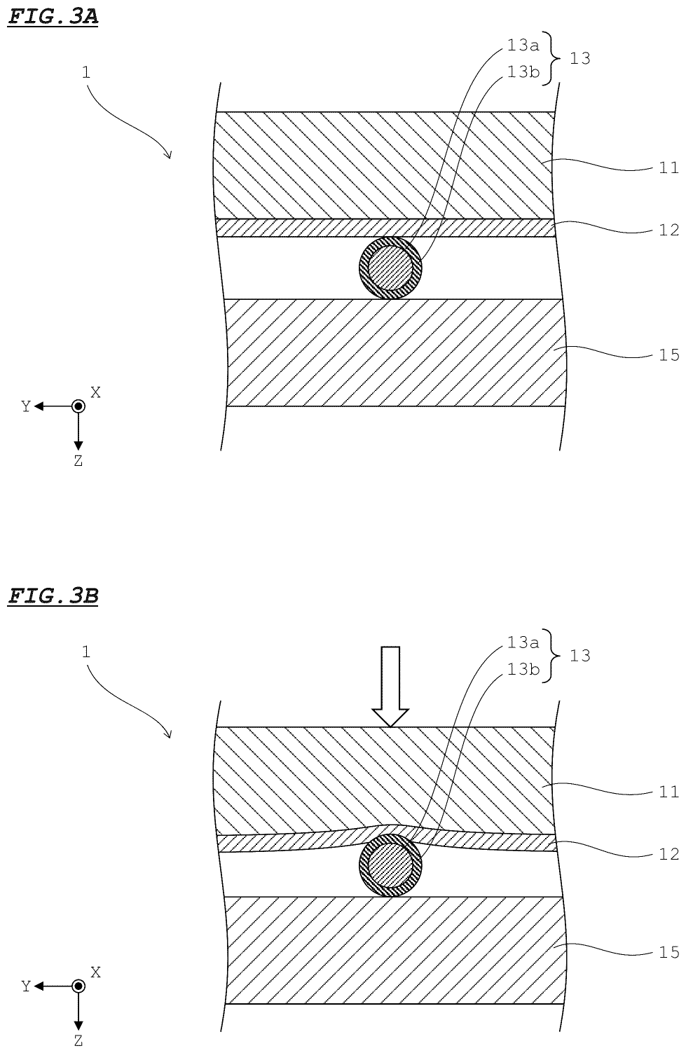

The conductor wire 13 is a covered copper wire, for example. The conductor wire 13 is composed of an electrically-conductive member 13a having a linear shape, and a dielectric body 13b formed on the surface of the electrically-conductive member 13a. The configuration of the conductor wire 13 will be described later with reference to FIGS. 3A, 3B.

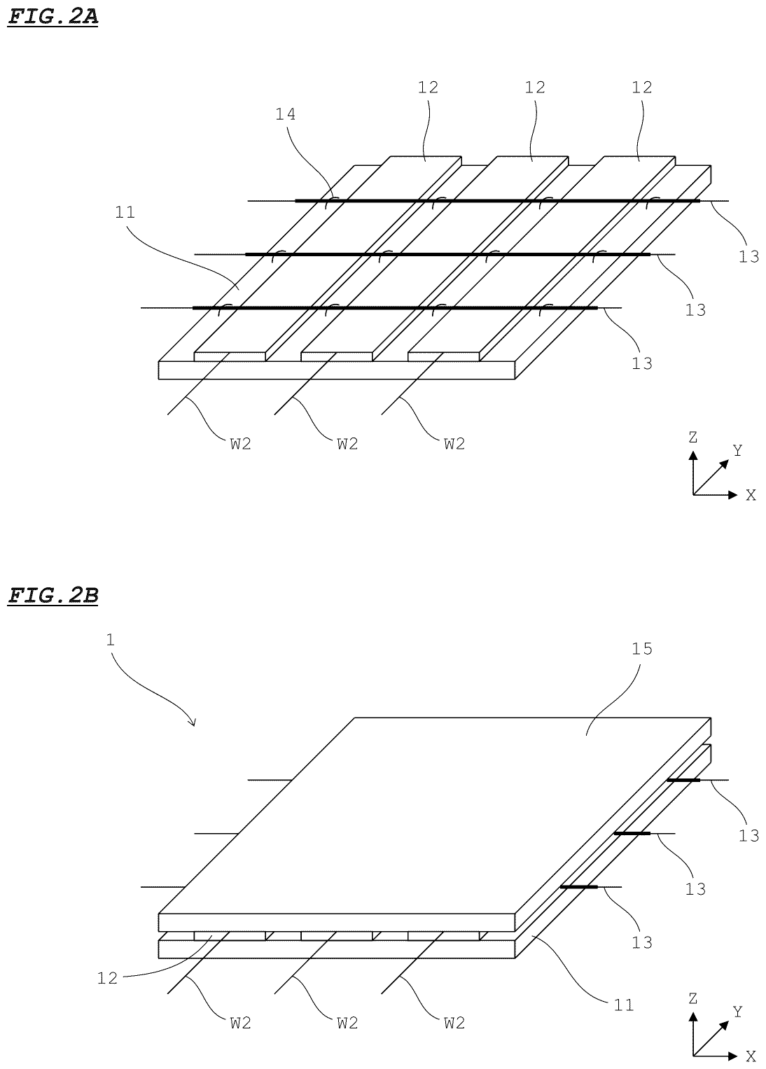

FIG. 2A is a perspective view schematically showing a state where threads 14 are set on the structure in FIG. 1B.

After the conductor wires 13 are disposed as shown in FIG. 1B, each conductor wire 13 is connected to the base member 11 by threads 14 so as to be able to move in the longitudinal direction (the X-axis direction) of the conductor wire 13. In the example shown in FIG. 2A, twelve threads 14 connect the conductor wires 13 to the base member 11 at positions other than the positions where the electrically-conductive elastic bodies 12 and the conductor wires 13 overlap each other. Each thread 14 is implemented by a chemical fiber, a natural fiber, a mixed fiber of the chemical fiber and the natural fiber, or the like.

FIG. 2B is a perspective view schematically showing a state where a base member 15 is set on the structure in FIG. 2A.

The base member 15 is set from above (the Z-axis positive side) the structure shown in FIG. 2A. The base member 15 is an insulative member. The material of the base member 15 is a resin material of at least one type selected from the group consisting of polyethylene terephthalate, polycarbonate, polyimide, and the like, for example. The base member 15 may be formed from the same material as that of the base member 11. The base member 15 has a flat plate shape parallel to an X-Y plane and has the same size and shape as those of the base member 11 in a plan view. The thickness in the Z-axis direction of the base member 15 is 0.01 mm to 2 mm, for example.

The outer peripheral four sides of the base member 15 are connected to the outer peripheral four sides of the base member 11 with a silicone rubber-based adhesive, a thread, or the like. Accordingly, the base member 15 is fixed to the base member 11. The conductor wires 13 are sandwiched by the electrically-conductive elastic bodies 12 and the base member 15. Accordingly, the load sensor 1 is completed as shown in FIG. 2B. The load sensor 1 can be used in a state of having been flipped upside down from the state shown in FIG. 2B.

FIG. 3A and FIG. 3B each schematically show a cross section of the load sensor 1 along a plane parallel to a Y-Z plane at the center position in the X-axis direction of the electrically-conductive elastic body 12. FIG. 3A shows a state where no load is applied, and FIG. 3B shows a state where a load is applied.

As shown in FIGS. 3A, 3B, the conductor wire 13 is composed of an electrically-conductive member 13a and a dielectric body 13b formed on the electrically-conductive member 13a. The electrically-conductive member 13a is a member that is electrically conductive and that has a linear shape. The dielectric body 13b covers the surface of the electrically-conductive member 13a. The electrically-conductive member 13a is formed from copper, for example. The diameter of the electrically-conductive member 13a is about 60 μm, for example.

The dielectric body 13b has an electric insulation property, and is formed from a resin material, a ceramic material, a metal oxide material, or the like, for example. The dielectric body 13b may be a resin material of at least one type selected from the group consisting of a polypropylene resin, a polyester resin (e.g., polyethylene terephthalate resin), a polyimide resin, a polyphenylene sulfide resin, a polyvinyl formal resin, a polyurethane resin, a polyamide imide resin, a polyamide resin, and the like. Alternatively, the dielectric body 13b may be a metal oxide material of at least one type selected from the group consisting of Al₂O₃, Ta₂O₅, and the like. The dielectric body 13b is formed at least in the range where the conductor wire 13 overlaps the electrically-conductive elastic body 12.

As shown in FIG. 3A, when no load is applied, the force applied between the electrically-conductive elastic body 12 and the conductor wire 13, and the force applied between the base member 15 and the conductor wire 13 are approximately zero. From this state, as shown in FIG. 3B, when a load is applied to the face on the Z-axis negative side of the base member 11, the electrically-conductive elastic body 12 and the base member 11 are deformed by the conductor wire 13.

As shown in FIG. 3B, due to the application of a load, the conductor wire 13 is brought close to the electrically-conductive elastic body 12 so as to be wrapped by the electrically-conductive elastic body 12. In association with this, the contact area between the conductor wire 13 and the electrically-conductive elastic body 12 increases. Accordingly, the capacitance between the electrically-conductive member 13a and the electrically-conductive elastic body 12 changes. The capacitance between the electrically-conductive member 13a and the electrically-conductive elastic body 12 is detected, whereby the load applied to this region is acquired.

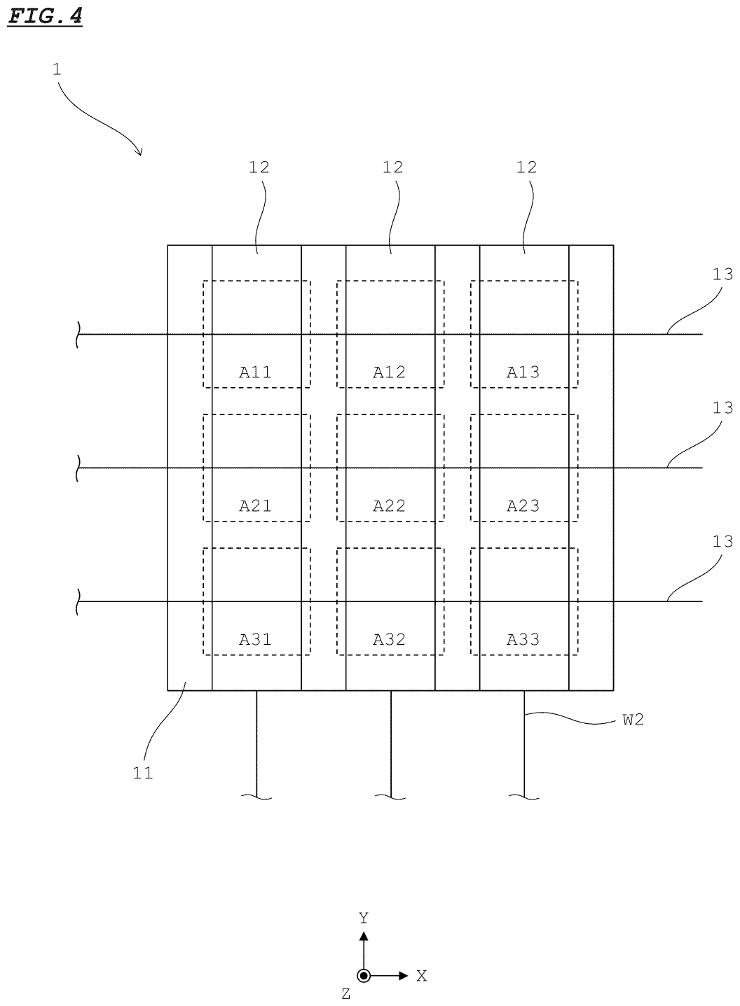

FIG. 4 is a plan view schematically showing a configuration of the inside of the load sensor 1. In FIG. 4, the threads 14 and the base member 15 are not shown for convenience.

As shown in FIG. 4, element parts A11, A12, A13, A21, A22, A23, A31, A32, A33 in which the capacitance changes in accordance with a load are formed at positions where the three electrically-conductive elastic bodies 12 and the three conductor wires 13 cross each other. Each element part includes an electrically-conductive elastic body 12 and a conductor wire 13 in the vicinity of the intersection between the electrically-conductive elastic body 12 and the conductor wire 13.

In each element part, the conductor wire 13 forms one pole (e.g., positive pole) for capacitance and the electrically-conductive elastic body 12 forms the other pole (e.g., negative pole) for capacitance. That is, the electrically-conductive member 13a (see FIGS. 3A, 3B) in the conductor wire 13 forms one electrode of the load sensor 1 (capacitance-type load sensor), the electrically-conductive elastic body 12 forms the other electrode of the load sensor 1 (capacitance-type load sensor), and the dielectric body 13b (see FIGS. 3A, 3B) included in the conductor wire 13 corresponds to a dielectric body that defines the capacitance in the load sensor 1 (capacitance-type load sensor).

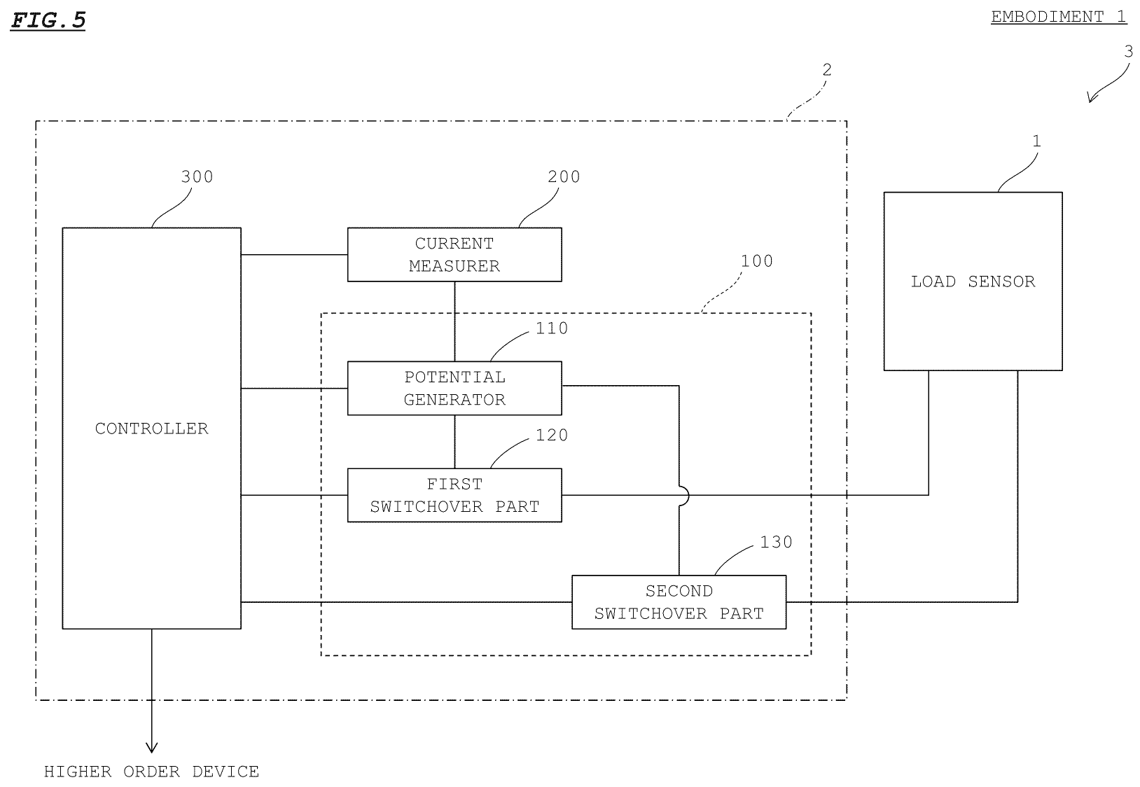

When a load is applied in the Z-axis direction to each element part, the conductor wire 13 is wrapped by the electrically-conductive elastic body 12. Accordingly, the contact area between the conductor wire 13 and the electrically-conductive elastic body 12 changes, and the capacitance between the conductor wire 13 and the electrically-conductive elastic body 12 changes. An end portion on the X-axis negative side of each conductor wire 13 and an end portion on the Y-axis negative side of the wiring cable W2 set to each electrically-conductive elastic body 12 are connected to a detecting circuit 2 described later with reference to FIG. 5.

When a load is applied to the element part A11, the contact area between the electrically-conductive member 13a of the conductor wire 13 and the electrically-conductive elastic body 12 increases via the dielectric body 13b in the element part A11. In this case, when the capacitance between the electrically-conductive elastic body 12 on the most X-axis negative side and the conductor wire 13 on the most Y-axis positive side is detected, the load applied to the element part A11 can be calculated. Similarly, in another element part as well, when the capacitance between the electrically-conductive elastic body 12 and the conductor wire 13 crossing each other in the other element part is detected, the load applied to the other element part can be calculated.

FIG. 5 is a block diagram showing a configuration of a load detecting device 3.

The load detecting device 3 includes the load sensor 1 described above and the detecting circuit 2. The detecting circuit 2 detects the capacitance in each element part of the load sensor 1. As described above, the capacitance in each element part changes in accordance with the load applied to the element part. The detecting circuit 2 applies a predetermined potential to both electrodes of each element part to detect the capacitance in the element part that changes in accordance with the load.

The detecting circuit 2 includes a potential applier 100, a current measurer 200, and a controller 300.

The potential applier 100 applies a predetermined potential to both electrodes of each element part. The potential applier 100 includes a potential generator 110, a first switchover part 120, and a second switchover part 130. The potential generator 110 generates a potential to be applied to both electrodes of each element part. The first switchover part 120 selectively applies a potential generated by the potential generator 110, to the three conductor wires 13 of the load sensor 1. The first switchover part 120 selectively applies a potential generated by the potential generator 110 to the three electrically-conductive elastic bodies 12 of the load sensor 1.

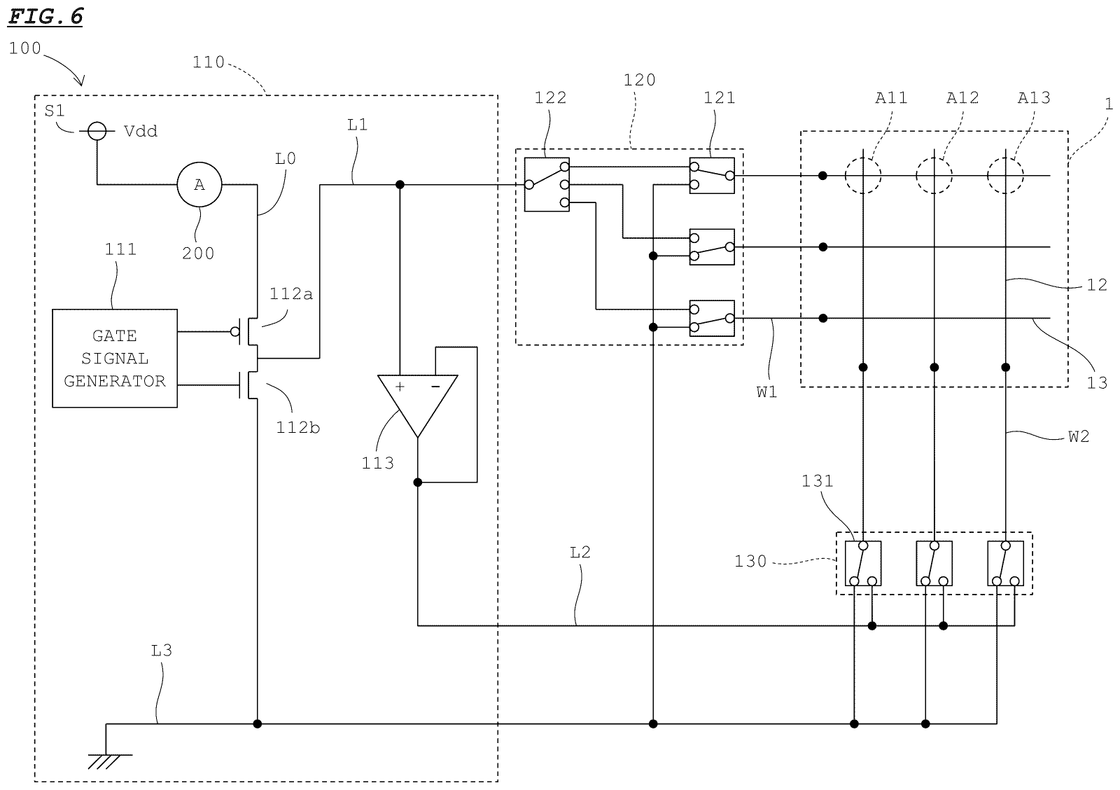

The current measurer 200 measures the value corresponding to the electric charge amount accumulated in the element part through the application of the potential. Here, as this value, the current flowing in a supply line L0 (see FIG. 6) of the potential generator 110 is measured by the current measurer 200.

The controller 300 controls the potential applier 100 such that a predetermined potential is applied to both electrodes of each element part. The controller 300 acquires a measurement value of the current measured by the current measurer 200 through the application of the potential, and based on the acquired measurement value, detects the capacitance in each element part.

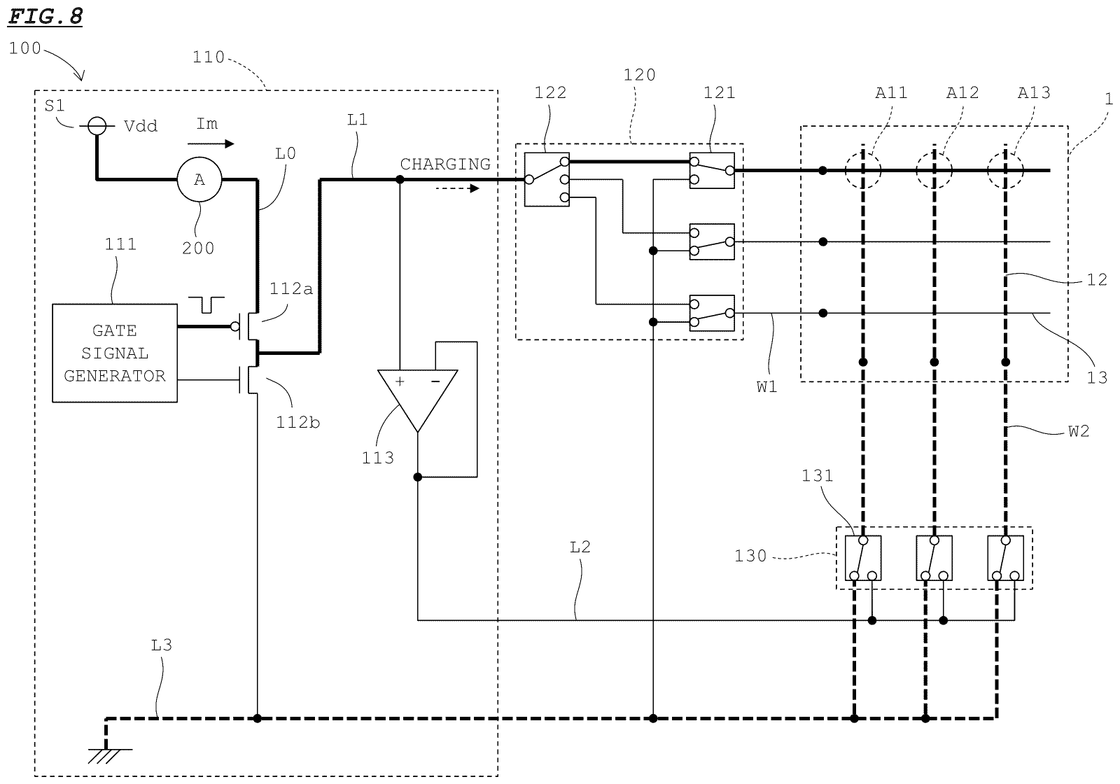

Specifically, the controller 300 acquires a first value from the current measured by the current measurer 200 in a first mode in which different potentials are applied to both electrodes of the element part serving as the measurement target, acquires a second value from the current measured by the current measurer 200 in a second mode in which the same potential is applied to both electrodes of the element part serving as the measurement target, and detects the capacitance in the element part serving as the measurement target, from the difference between the first value and the second value. The capacitance detection process in the controller 300 will be described later with reference to FIG. 8 to FIG. 14.

FIG. 6 is a circuit diagram showing a configuration of the potential applier 100.

In FIG. 6, for convenience, as the configuration of the load sensor 1, only the conductor wires 13 and the electrically-conductive elastic bodies 12 are shown, and each electrically-conductive elastic body 12 is shown in a linear shape. For convenience, in order to show that the current measurer 200 measures the current flowing in the supply line L0 of the potential generator 110, the current measurer 200 is included in the broken line frame showing the potential generator 110.

The potential generator 110 includes a gate signal generator 111, switching elements 112a, 112b, and an equipotential generator 113.

The gate signal generator 111 generates a gate signal for making the switching elements 112a, 112b conductive. The switching element 112a is implemented by a P-type FET and becomes conductive by a low-level gate signal being applied to the gate. The switching element 112b is implemented by an N-type FET and becomes conductive by a high-level gate signal being applied to the gate.

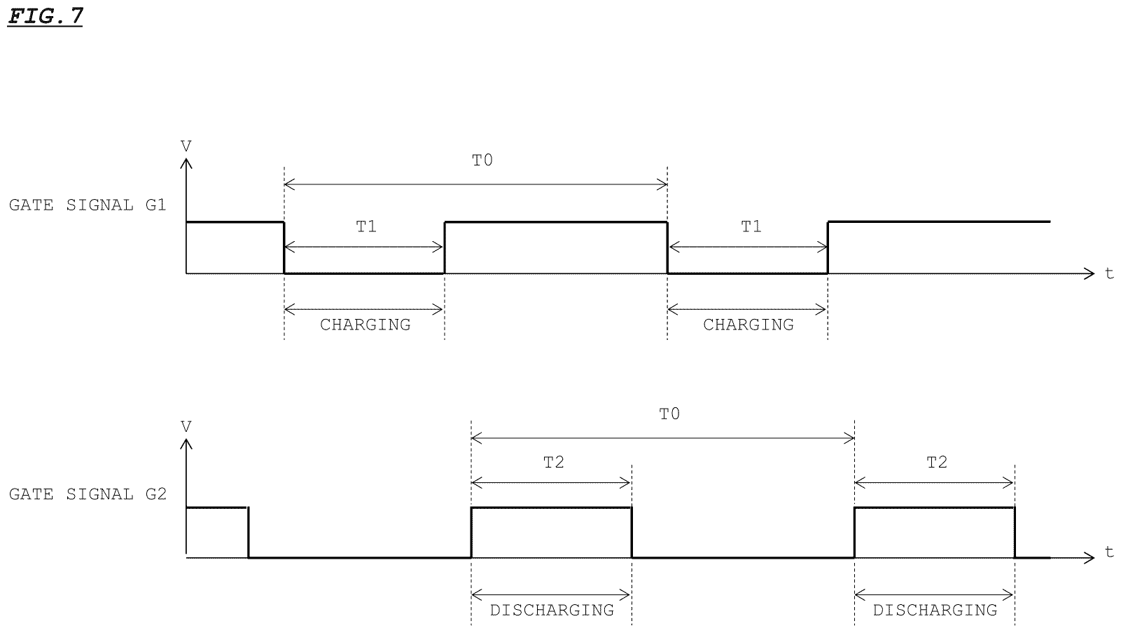

FIG. 7 is a time chart showing a gate signal outputted from the gate signal generator 111.

A gate signal G1 on the upper row is a signal that is supplied to the gate of the switching element 112a. A gate signal G2 on the lower row is a signal that is supplied to the gate of the switching element 112b.

The gate signal G1 is at a low level (zero level) in a period T1. The period T1 appears in a cycle TO. The gate signal G2 is at a high level in the period T2. The period T2 appears in the cycle TO. The appearance timing of the period T1 and the period T2 are shifted from each other. Therefore, when either one of the switching elements 112a, 112b is in a conductive state, the other is in a non-conductive state. As described later, in the period T1, charging with respect to the element part is performed, and in the period T2, discharging with respect to the element part is performed.

With reference back to FIG. 6, the equipotential generator 113 is an operational amplifier, generates a potential equal to the potential in a supply line L1, and applies the potential to the supply line L1.

The first switchover part 120 selectively connects either one of the supply line L1 and a ground line L3, to wiring cables W1 respectively drawn from a plurality of conductor wires 13 (the electrically-conductive members 13a).

Specifically, the first switchover part 120 includes three multiplexers 121 and one multiplexer 122. The supply line L1 is connected to the input-side terminal of the multiplexer 122. The multiplexer 122 is provided with three output-side terminals. The three multiplexers 121 are respectively connected to the three output-side terminals of the multiplexer 122. The three multiplexers 121 are provided so as to correspond to the three conductor wires 13 (the electrically-conductive members 13a), respectively. To the output-side terminal of each multiplexer 121, the electrically-conductive member 13a (the wiring cable W1) of a corresponding conductor wire 13 is connected.

Each multiplexer 121 is provided with two input-side terminals. The multiplexer 122 is connected to one input-side terminal of the multiplexer 121, and to this input-side terminal, a power supply potential Vdd is applied via the supply line L1. The power supply potential Vdd is a potential generated by a power supply S1. The other input-side terminal of the multiplexer 121 is connected to the ground line L3.

The second switchover part 130 selectively connects either one of a supply line L2 and the ground line L3 to each electrically-conductive elastic body 12 (the wiring cable W2).

Specifically, the second switchover part 130 includes three multiplexers 131. The three multiplexers 131 are provided so as to correspond to the three electrically-conductive elastic bodies 12, respectively. To the output-side terminal of each multiplexer 131, the wiring cable W2 connected to a corresponding electrically-conductive elastic body 12 is connected. Each multiplexer 131 is provided with two input-side terminals. The supply line L2 is connected to one input-side terminal of the multiplexer 131. The ground line L3 is connected to the other input-side terminal of the multiplexer 131.

The first switchover part 120 and the second switchover part 130 are controlled by the controller 300 in FIG. 5. Accordingly, the power supply potential Vdd, the potential from the equipotential generator 113, or the ground potential is applied to the three conductor wires 13 (the wiring cables W1) and the three electrically-conductive elastic bodies 12 (the wiring cables W2).

The current measurer 200 measures the current flowing in the supply line L0. That is, when the switching element 112a is in a conductive state and the switching element 112b is in a non-conductive state (the period T1 in FIG. 7), the current measurer 200 measures the current flowing in the supply line L0, i.e., the current according to the electric charge amount that moves to the load sensor 1 via the supply lines L0, L1 and the first switchover part 120.

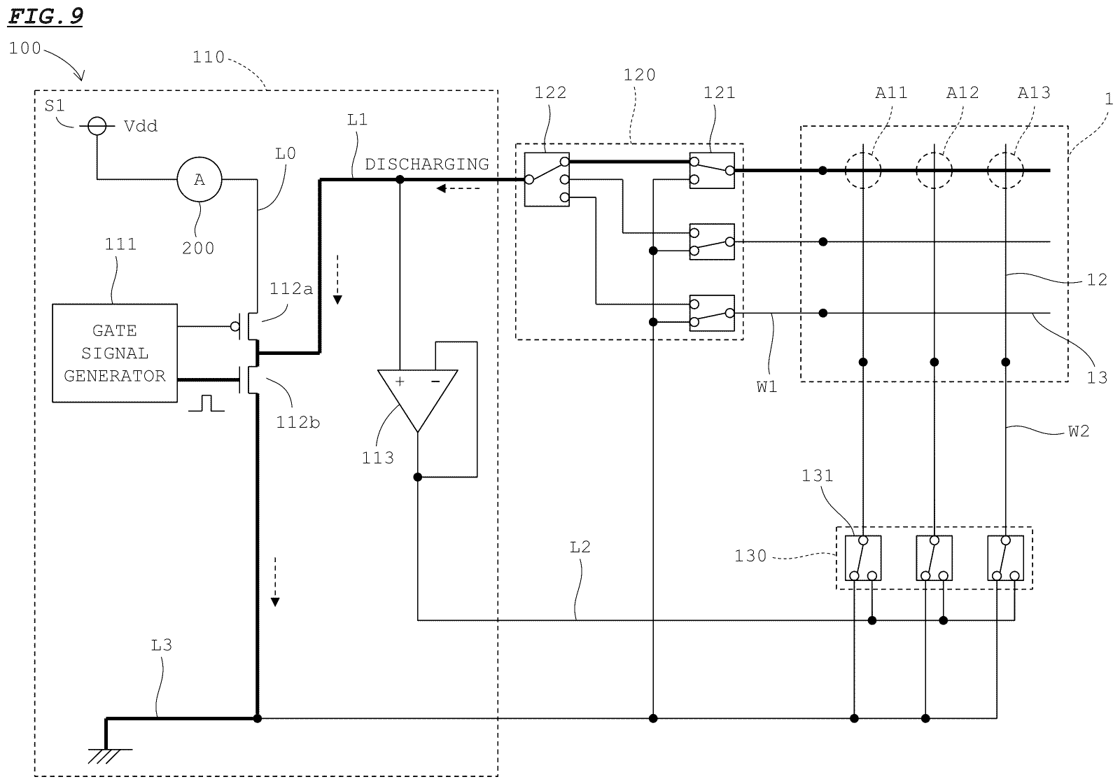

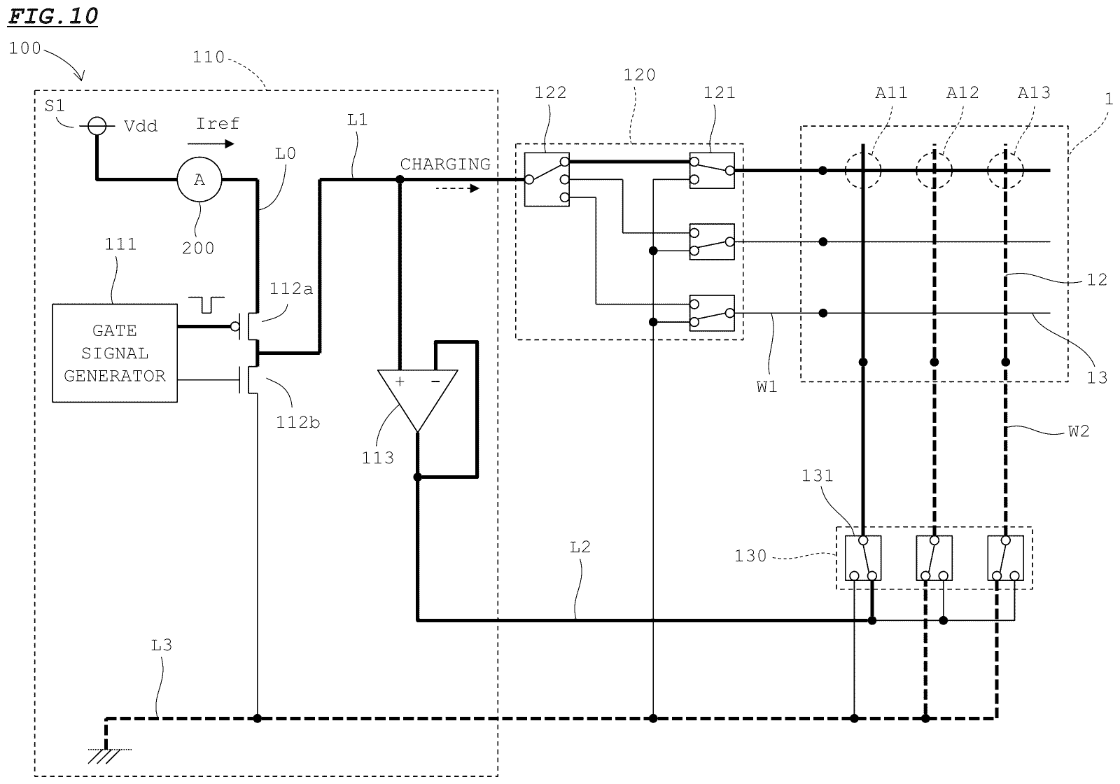

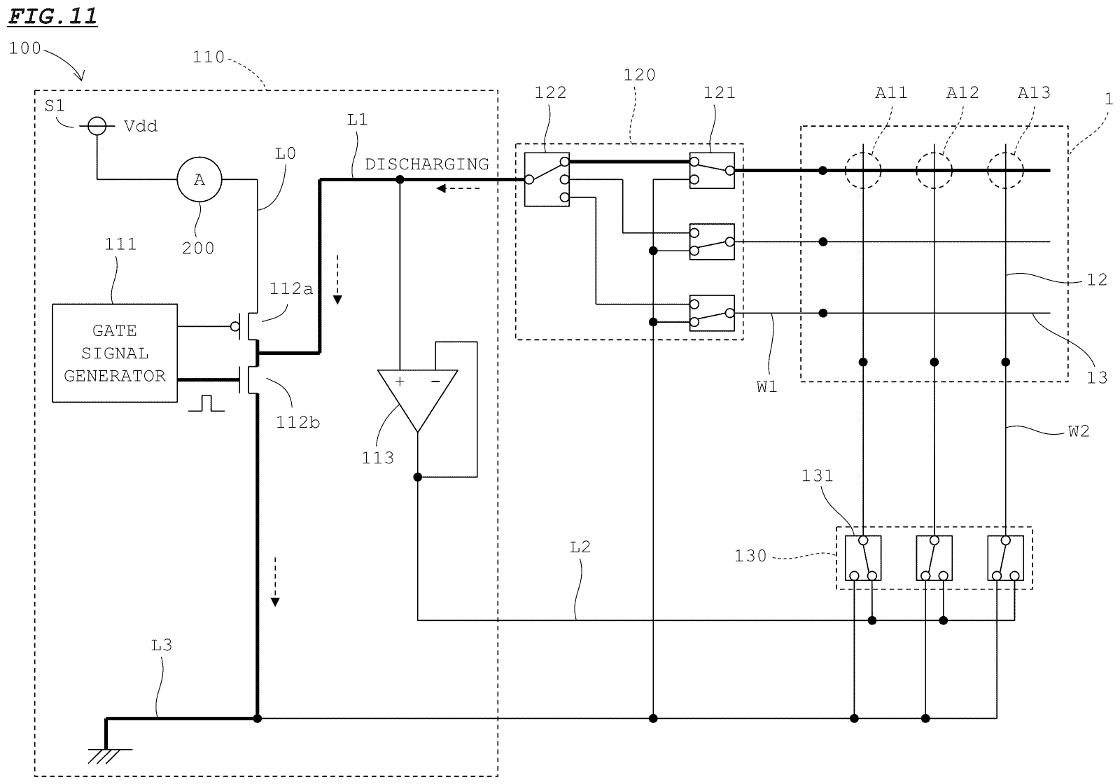

Next, the detection operation of the capacitance in each element part will be described with reference to FIG. 6 and FIG. 8 to FIG. 11. Here, the element part A11 in FIG. 6 is the detection target of the capacitance. In FIG. 8 and FIG. 10, the thick solid line indicates the path along which a potential equivalent to the power supply potential Vdd is applied to the load sensor 1, and the thick broken line indicates the path of the ground potential. In FIG. 9 and FIG. 11, the thick solid line indicates the path of the current flowing to the ground.

When the detection target of the capacitance is the element part A11, the multiplexers 121, 122 of the first switchover part 120 and the multiplexers 131 of the second switchover part 130 are set to be in the state in FIG. 6. In this state, when the switching element 112a is switched into a conductive state due to the gate signals G1, G2 in FIG. 7, the power supply potential Vdd is applied to the conductor wire 13 in the row including the element part A11 of the load sensor 1, as shown in FIG. 8. Accordingly, the power supply potential Vdd is applied to one electrode (the conductor wire 13) of each of the three element parts A11 to A13 in this row. At this time, the other electrodes (the three electrically-conductive elastic bodies 12) of these three element parts A11 to A13 are connected to the ground via the second switchover part 130. Therefore, different potentials are applied to both electrodes of these element parts A11 to A13. That is, in FIG. 8, potential application according to the first mode is performed.

Through this potential application, electric charge is accumulated in the three element parts A11 to A13, and a current Im flows in the supply line L0. Until accumulation of the electric charge with respect to the three element parts A11 to A13 is saturated, the current Im flows in the supply line L0. The controller 300 in FIG. 5 calculates the average current value of the current Im in the period T1 in FIG. 7, from the measurement value obtained by the current measurer 200.

Then, when the period T1 has ended, the switching element 112a becomes non-conductive, and application of the power supply potential Vdd to the supply line L1 is blocked. Then, when the period T2 in FIG. 7 has arrived, the switching element 112b becomes conductive, and as shown by the broken line arrows in FIG. 9, the current flows from the supply line L1 to the ground line L3, and the electric charge charged in the element parts A11, A12, A13 is discharged to the ground.

Then, when the period T2 has ended, the switching element 112b becomes non-conductive, and connection of the ground line L3 to the supply line L1 is blocked. Then, during the period until the period T1 in FIG. 7 arrives, the multiplexer 131 in the column of the element part A11, among the three multiplexers 131 of the second switchover part 130, is switched to the terminal side of the supply line L2. In this state, when the next period T1 in FIG. 7 has arrived, the switching element 112a becomes conductive, and as shown in FIG. 10, the power supply potential Vdd is applied to the supply line L1.

In this case, to the other electrode (the electrically-conductive elastic body 12) of the element part A11, a potential generated by the equipotential generator 113, i.e., a potential equivalent to the power supply potential Vdd, is applied. Therefore, to both electrodes of the element part A11, the same potential is applied. On the other hand, to both electrodes of the element parts A12, A13, different potentials (the potential of the power supply potential Vdd and the ground potential) are applied, as in the case of FIG. 8. That is, in FIG. 10, potential application according to the first mode is performed.

Through this potential application, electric charge is accumulated in the three element parts A11 to A13, and a current Iref flows in the supply line L0. The current Iref flows in the supply line L0 until accumulation of electric charge with respect to the three element parts A11 to A13 is saturated. The controller 300 in FIG. 5 calculates the average current value of the current Iref in the period T1 in FIG. 7, from the measurement value obtained by the current measurer 200.

Then, when the period T1 has ended, the switching element 112a becomes non-conductive, and application of the power supply potential Vdd to the supply line L1 is blocked. Then, when the period T2 in FIG. 7 has arrived, the switching element 112b becomes conductive, and as shown by the broken line arrows in FIG. 11, the current flows from the supply line L1 to the ground line L3, and electric charge charged in the element parts A11, A12, A13 is discharged to the ground. Then, the operation for detecting the capacitance with respect to the element part A11 ends.

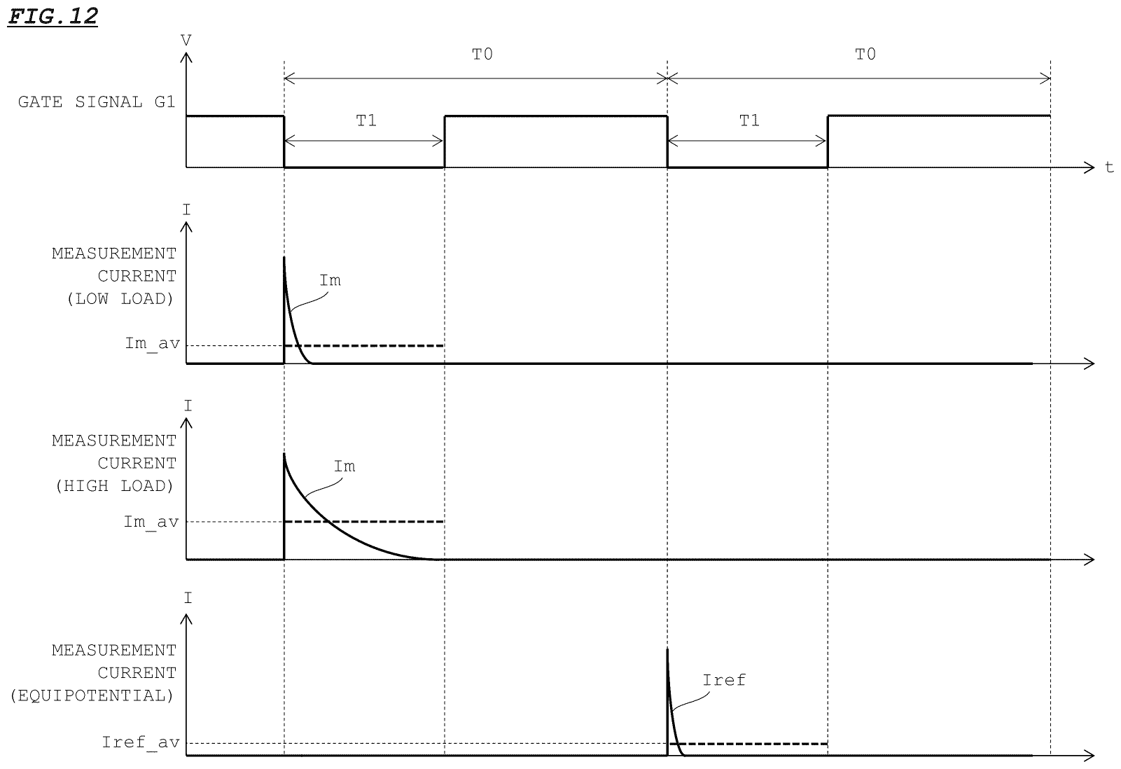

FIG. 12 is a time chart schematically showing currents measured by the current measurer 200 through the above operation.

On the uppermost row in FIG. 12, the gate signal G1 in FIG. 7 is shown. In the second row and the third row from the top in FIG. 12, the currents Im that are measured in the operation in FIG. 8 in the cases where the load applied to the element parts A11, A12, A13 is low and high are shown, respectively. In the lowest row in FIG. 12, the current Iref that is measured in the operation in FIG. 8 in the case where the load applied to the element parts A11, A12, A13 is low is shown.

As shown in the second row and the third row from the top in FIG. 12, the larger the load applied to the element parts A11, A12, A13 is, the higher the capacitance becomes, and thus, the period (the period until accumulation of electric charge is saturated) until the current Im converges to zero becomes long. Therefore, the period T1 is set to be slightly longer than the period until the current Im converges to zero when the maximum load in the load detection range (dynamic range) is applied to the element parts A11, A12, A13, i.e., when the total capacitance in the element parts A11, A12, A13 is at the maximum.

As shown in the lowest row in FIG. 12, the current Iref that is measured in the operation in FIG. 10 converges to zero earlier than the current Im in the second row from the top in FIG. 12, since the potentials applied to both electrodes of the element part A11 are different from those in the case of FIG. 8.

Here, the current Im that is measured in the first mode in FIG. 8 includes, in addition to the current component based on electric charge accumulated in the element part A11 serving as the measurement target, current components based on electric charge accumulated in other element parts A12, A13, and further includes current components based on electric charge accumulated in element parts other than the element parts A12, A13 and the parasitic capacitance in circuitries and wiring cables present between the supply line L0 and the load sensor 1.

Similarly, the current Iref that is measured in the second mode in FIG. 10 includes, in addition to the current component based on electric charge accumulated in the element part A11 serving as the measurement target, current components based on electric charge accumulated in other element parts A12, A13, and further includes current components based on electric charge accumulated in element parts other than the element parts A12, A13 and the parasitic capacitance in circuitries and wiring cables present between the supply line L0 and the load sensor 1.

As seen through comparison between FIG. 8 and FIG. 10, between the measurement methods of these two currents Im, Iref, only the potentials applied to the column of the element part A11 are different. Here, in FIG. 10, since the same potential is applied to both electrodes of the element part A11, electric charge is hardly accumulated in the element part A11. Therefore, on the current Iref that is measured in the operation in FIG. 10, current components based on electric charge accumulated in the element part A11 serving as the measurement target is hardly superposed, and mainly, current components based on electric charge accumulated in other element parts A12, A13 and current components based on electric charge accumulated in other element parts and the parasitic capacitance are superposed.

Therefore, when the electric charge amount corresponding to the current Iref is subtracted from the electric charge amount corresponding to the current Im, the electric charge amount accumulated in the above elements other than the element part A11 can be canceled. That is, the difference between the electric charge amount corresponding to the current Im and the electric charge amount corresponding to the current Iref is approximately equivalent to the electric charge amount accumulated in the single element part A11 when the power supply potential Vdd and the ground potential are applied to both electrodes of the element part A11.

Therefore, from average currents Im_av, Iref_av of the currents Im, Iref, a capacitance C of the element part A11 can be calculated by the formula below.

$$C = ( Qm - Qref ) / Vdd \qquad ( 1 )$$

$$Qm = Im\_av \cdot T 1 \qquad ( 1 - 1 )$$

$$Qref = Iref\_av \cdot T 1 \qquad ( 1 - 2 )$$

In Formula (1), (Im_av-Iref_av) T1 is the difference between an electric charge amount Qm based on the current Im and an electric charge amount Qref based on the current Iref. That is, the electric charge amount Qm is calculated from Formula (1-1), and the electric charge amount Qref is calculated from Formula (1-2). By calculating the capacitance in the element part A11 from Formula (1), it is possible to acquire highly accurate capacitance in which the influence of parasitic capacitance and the like is suppressed, as described above.

In this method, in a state where the accumulation of electric charge has been completed and the currents Im, Iref have converged to zero and become stable, the average currents Im_av, Iref_av which are parameter values of Formula (1) are acquired, and the electric charge amounts Qm, Qref in Formula (1-1) and Formula (1-2) are acquired. Therefore, the capacitance calculated from Formula (1) does not include influence of parasitic inductance and parasitic impedance.

In addition, even when loads are applied to the element parts A12, A13 in the same row as that of the element part A11, the electric charge amount accumulated in these element parts A12, A13 is canceled by Formula (1) above. Therefore, the capacitance in the element part A11 serving as the measurement target can be accurately calculated.

When FIG. 8 and FIG. 11 are compared with each other, the potential applied to the other electrode (the electrically-conductive elastic body 12) of the other two element parts in the same column as that of the element part A11 serving as the measurement target is different between FIG. 8 and FIG. 11. However, in the operation state in FIG. 10, a current, not the power supply potential Vdd, is supplied from the equipotential generator 113 to these two other element parts. Therefore, even when the application state of voltage to the other electrode (the electrically-conductive elastic body 12) of these two other element parts is different between FIG. 8 and FIG. 11, this difference does not influence the current flowing in the supply line L0. Therefore, from Formula (1) above, the capacitance in the element part A11 serving as the measurement target can be accurately calculated.

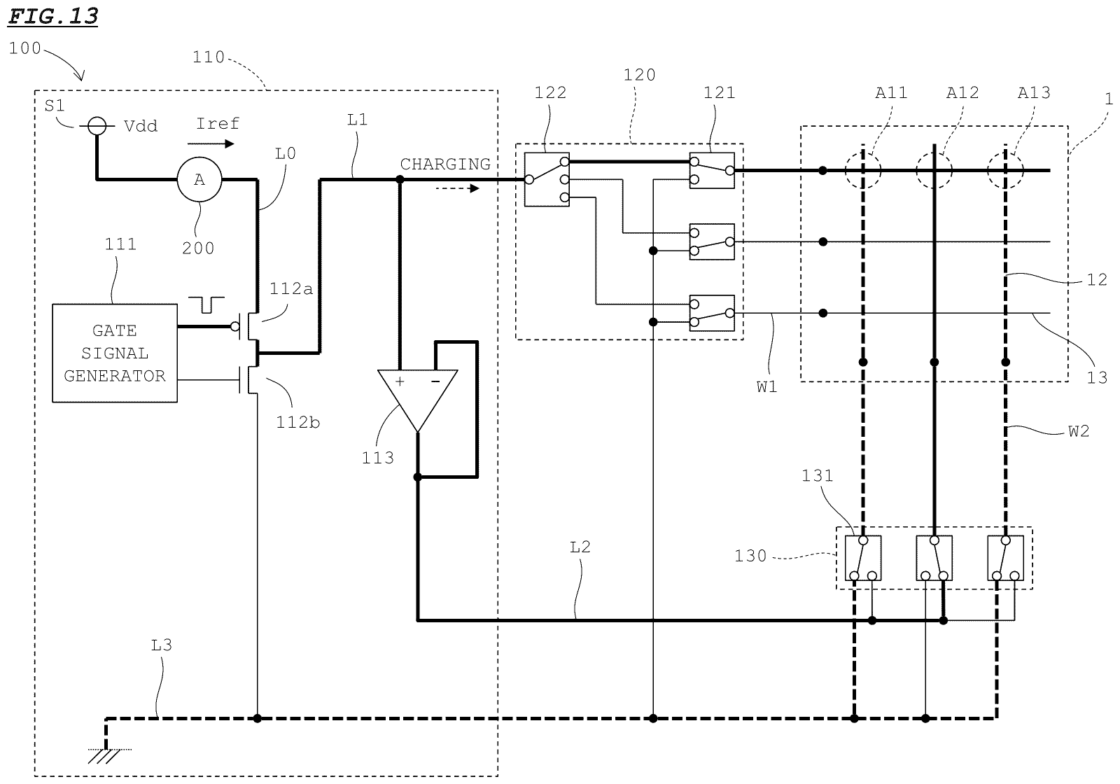

Thus, when the currents Im, Iref necessary for calculation of the capacitance in the element part A11 have been measured through the operations in FIG. 6 and FIG. 8 to FIG. 11, the current Iref necessary for calculation of the capacitance in the next element part A12 is calculated. In this case, from the state in FIG. 6, the center multiplexer 131 of the second switchover part 130 is switched to the terminal side of the supply line L2. In this state, when the next period T1 in FIG. 7 has arrived, a potential equivalent to the power supply potential Vdd is applied to the other electrode (the electrically-conductive elastic body 12) of the element part A12 as shown in FIG. 13, and the current Iref is measured. From this measurement, the controller 300 calculates the average current Iref_av. This average current Iref_av and the above average current Im_av are applied to Formula (1) above, whereby the capacitance in the element part A12 is calculated.

With respect to the element part A13 as well, as in the case of the element part A12, the rightmost multiplexer 131 of the second switchover part 130 is switched, and from the measurement result of the current Iref in the next period T1, the capacitance is calculated by Formula (1) above. With respect to the element parts in the center row and the lowest row as well, the first switchover part 120 is switched such that the power supply potential Vdd is applied to these rows, and a process similar to the above is executed, whereby the capacitance in each element part is calculated. Then, the capacitance detection process with respect to all the element parts ends.

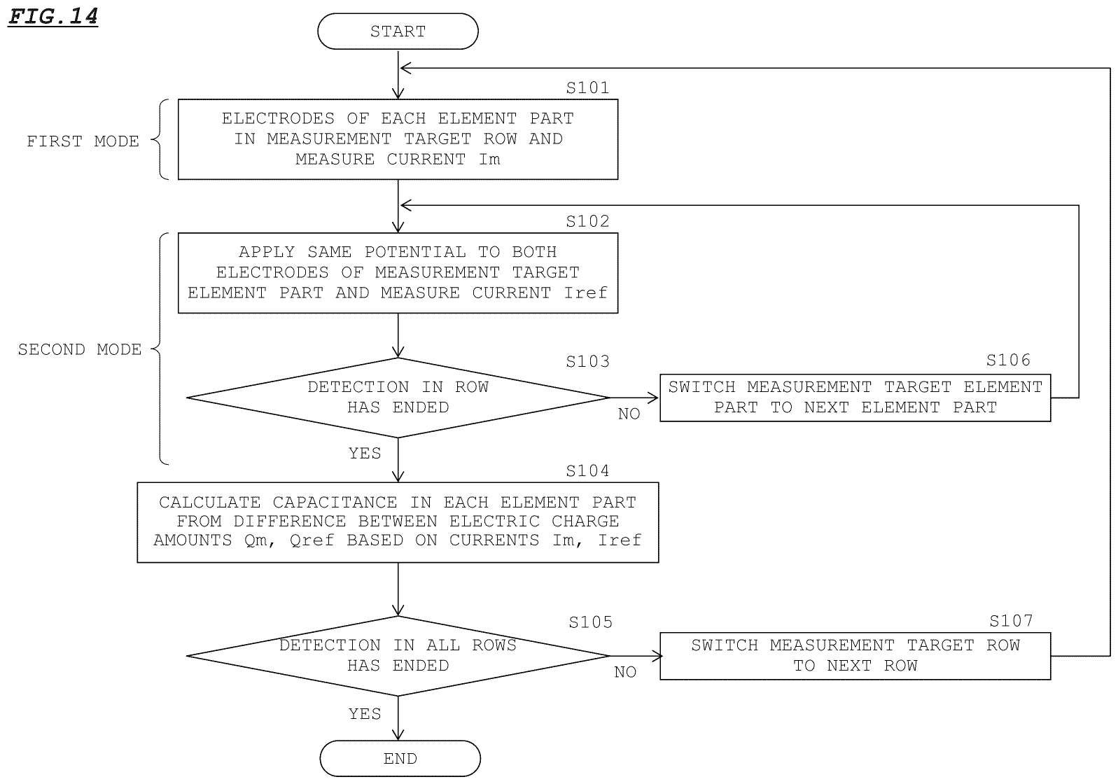

FIG. 14 is a flowchart showing the capacitance detection process according to the above operation.

In FIG. 14, step S101 corresponds to the measurement process based on the potential in the first mode described above, and steps S102, S103, S106 correspond to the measurement process based on the potential in the second mode described above.

The controller 300 causes different potentials to be applied to both electrodes of each element part in the row serving as the measurement target, to measure the current Im (S101). The operation according to this step corresponds to the operation in FIG. 8. In this step, the controller 300 acquires the average current Im_av described above from the measurement result of the current Im.

Next, the controller 300 causes the same potential to be applied to both electrodes of the element part serving as the measurement target included in this row, to measure the current Iref (S102). The operation according to this step corresponds to the operation in FIG. 10. In this step, the controller 300 acquires the average current Iref_av described above from the measurement result of the current Iref.

The controller 300 determines whether or not the current Iref has been measured with respect to all the element parts in this row (S103). When the determination in step S103 is NO, the controller 300 causes the measurement target to be switched to the next element part in this row, to measure the current Iref (S102). The operation according to this step corresponds to the operation in FIG. 13. In this step, the controller 300 acquires the average current Iref_av described above from the measurement result of the current Iref.

Then, until the current Iref is measured with respect to all the element parts included in the row serving as the measurement target (S103: NO), the controller 300 repeats the processes in steps S106, S102. Then, when the current Iref has been measured with respect to all the element parts included in the row serving as the measurement target and the average current Iref_av of these element parts has been acquired (S103: YES), the controller 300 calculates the capacitance in each element part in this row from the difference in the electric charge amount based on the currents Im, Iref (S104). Specifically, the controller 300 applies the common average current Im_av acquired in step S101 and the average current Iref_av with respect to each element part acquired in step S102, to Formula (1) above for each element part, to calculate the capacitance in each element part in the row serving as the measurement target.

Then, when the detection of the capacitance with respect to this row has ended, the controller 300 determines whether or not the detection of the capacitance has ended with respect to all the rows included in the load sensor 1 (S105). When the determination in step S105 is NO, the controller 300 causes the row serving as the measurement target to be switched to the next row (S107) and executes the processes in step S101 and thereafter. Accordingly, the capacitance in each element part in the next row is detected. Until the process is executed with respect to all the rows (S105: NO), the controller 300 causes the row serving as the measurement target to be sequentially switched (S107), to repeatedly execute the processes in step S101 and thereafter. Then, when the capacitance has been detected with respect to the element parts in all the rows (S105: YES), the controller 300 ends the process in FIG. 14.

In the flowchart in FIG. 14, after the measurement of the current Im in the first mode (step S101) has been performed, the measurement of the current Iref for each element part in the second mode (steps S102, S103, S106) is performed. However, after the measurement of the current Iref for each element part in the second mode (steps S102, S103, S106) has been performed, the measurement of the current Im in the first mode (step S101) may be performed.

In FIG. 14, step S104 may be moved to be between step S102 and step S103, and every time the measurement of the current Iref with respect to the element part serving as the measurement target is performed in step S102, the capacitance in the element part serving as the measurement target may be calculated. Alternatively, the process in step S104 may be moved to be after step S105, and after the process with respect to all the rows has ended, calculation of the capacitance with respect to each element part may be performed.

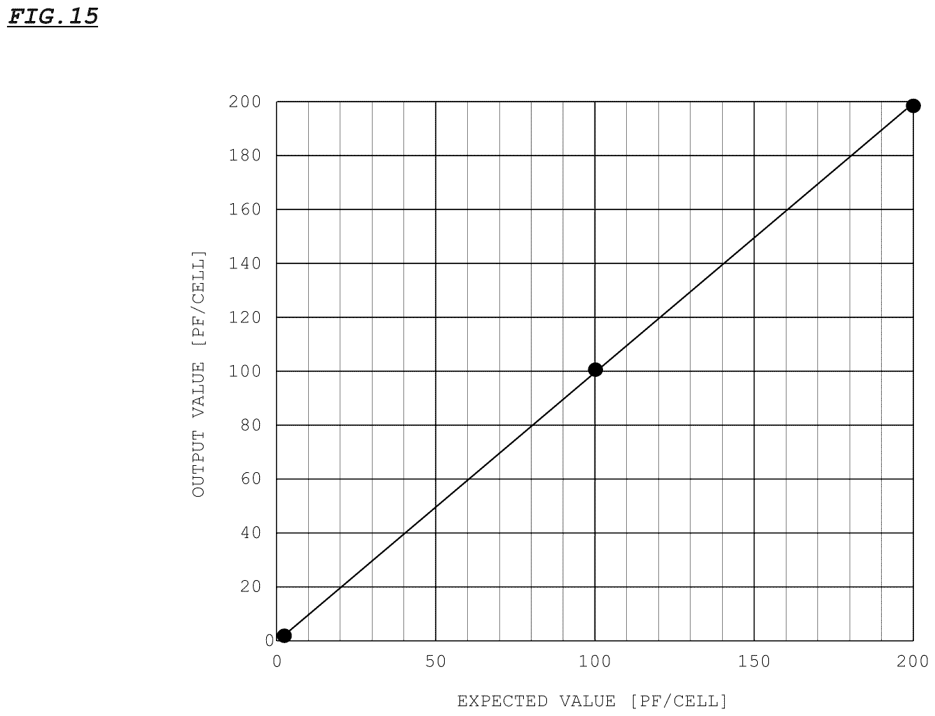

FIG. 15 is a graph showing a simulation result of the capacitance that is detected in the capacitance detection process in FIG. 14.

In this simulation, the capacitance detected through the above process was obtained when the capacitance in a predetermined element part was changed. In FIG. 15, the horizontal axis represents the capacitance set in the target element part, and the vertical axis represents the capacitance detected through the above process.

As shown in FIG. 15, the capacitance detected through the above process approximately matched with the capacitance set to the target element part, and a linear, straight approximate line was acquired from the plots of the simulation result. Thus, it was possible to confirm that, with the above process, capacitance in which the influence of parasitic capacitance, parasitic inductance, and the like is effectively suppressed can be acquired for each element part.

### Effects of Embodiment 1

According to the above embodiment, the following effects can be exhibited.

The electric charge amount Qm (the first value) based on the current Im reflects the electric charge amount accumulated in the element part serving as the measurement target, and the electric charge amount based on other element parts and unnecessary capacitance such as parasitic capacitance in circuitries and wiring cables. The electric charge amount Qref (the second value) based on the current Iref mainly reflects the electric charge amount based on other element parts and unnecessary capacitance such as parasitic capacitance in circuitries and wiring cables. Therefore, when the difference between the electric charge amount Qm (the first value) and the electric charge amount Qref (the second value) is taken, influence of the electric charge amount based on unnecessary capacitance is canceled from the current Im (the first value), and this difference mainly reflects the electric charge amount accumulated in the element part serving as the measurement target. Therefore, when the capacitance in the element part serving as the measurement target is detected from this difference, the capacitance in which influence of the unnecessary electric charge amount is effectively suppressed can be acquired. Thus, the detection accuracy of the load applied to the element part serving as the measurement target can be enhanced.

In addition, for detection of the capacitance, it is not necessary to separately provide a special circuit, and it is sufficient that the potential to be applied to both electrodes of the element part is switched as described above. Therefore, the capacitance in the element part can be accurately detected with a simple configuration.

As shown in FIG. 8 and FIG. 10, as the electric quantity which changes due to charging of electric charge with respect to the element part, the current measurer 200 measures the current flowing in the charging path between one electrode (the conductor wire 13) and the power supply S1 during potential application. Accordingly, the currents Im, Iref according to the electric charge amount in the element part serving as the measurement target and the electric charge amount of the other unnecessary capacitance can be measured. Therefore, from the difference between the electric charge amounts Qm and Qref based on these currents Im, Iref, the capacitance in the element part serving as the measurement target can be appropriately acquired.

As described with reference to FIG. 12, the controller 300 acquires, as the first value, the electric charge amount Qm until completion of charging, from the current Im (the average current Im_av) measured by the current measurer 200 in the first mode, acquires, as the second value, the electric charge amount Qref until completion of charging, from the current Iref (the average current Iref_av) measured by the current measurer 200 in the second mode, and calculates the capacitance in the element part serving as the measurement target, from the electric charge amounts Qm, Qref and a potential difference V between different potentials, by Formula (1) above. Accordingly, as described above, the capacitance in the element part serving as the measurement target can be accurately acquired.

As shown in FIG. 6, the load sensor 1 includes a plurality of element parts, the potential applier 100 is configured to be able to switch an element part to which a potential is applied, and in the first mode and the second mode, the controller 300 controls the potential applier 100 to apply a potential to each element part, acquires, from the current measurer 200, the current Im and the current Iref (electric quantity) with respect to each element part, and detects the capacitance with respect to each element part from the electric charge amount Om (the first value) and the electric charge amount Qref (the second value) based on the acquired current Im and current Iref (electric quantity) in the each element part. With this configuration, since a plurality of element parts are disposed in the load sensor 1, the load detection range can be expanded. Since the above process is executed with respect to each element part, the capacitance applied to each element part can be accurately detected.

As shown in FIG. 6, the plurality of element parts are disposed in a matrix shape so as to be arranged in a plurality of rows and a plurality of columns. The element parts in the same row each have one of both electrodes thereof connected to each other, the element parts in the same column each have the other of both electrodes thereof connected to each other, and the potential applier 100 includes the multiplexers 121, 122, 131 (switching element) configured to switch the row and the column to which a potential is applied. With this configuration, since the plurality of element parts are disposed in a matrix shape, distribution of the load in an area spreading in a quadrangular shape can be detected by these element parts. In addition, since the row and the column to which potentials are applied are switched by the multiplexers 121, 122, 131 (switching element), predetermined potentials can be respectively applied to two electrodes of the element part present at the crossing position of the row and the column after the switching, and the capacitance in the element part can be smoothly detected through the above control.

As shown in FIG. 14, the controller 300, in the first mode, causes different potentials to be simultaneously applied to both ends of all the element parts included in the row serving as the measurement target, and acquires the electric charge amount Qm (the first value) being common between these element parts (S101), and in the second mode, causes, out of the plurality of element parts included in the row serving as the measurement target, the element part serving as the measurement target for which the same potential is applied to both electrodes thereof, to be sequentially switched (S106), acquires the electric charge amount Qref (the second value) for each element part serving as the measurement target (S102, S103), and detects the capacitance in each element part from the difference between the common electric charge amount Qm (the first value) and the electric charge amount Qref (the second value) in each element part (S104). With this process, the electric charge amounts Qm (the first value) are acquired in a batch with respect to the element parts in one row, and thus, the capacitance detection process with respect to each element part can be performed quickly and in a simple manner.

### Modification 1

In Embodiment 1 above, as shown in FIG. 14, in the first mode, different potentials are simultaneously applied to both electrodes of all the element parts included in the row serving as the measurement target and the current Im being common between these element parts is measured (S101), then, in the second mode, out of the plurality of element parts included in the row serving as the measurement target, the element part serving as the measurement target for which the same potential is applied to both electrodes thereof is sequentially switched, and the current Iref is measured for each element part serving as the measurement target (S102, S103, S106).

In contrast, in Modification 1, in the second mode, the same potential is simultaneously applied to both electrodes of all the element parts included in the row serving as the measurement target and the current Iref being common between these element parts is measured, then, in the first mode, out of the plurality of element parts included in the row serving as the measurement target, the element part serving as the measurement target for which different potentials are applied to both electrodes thereof is sequentially switched, and the current Im is measured for each element part serving as the measurement target.

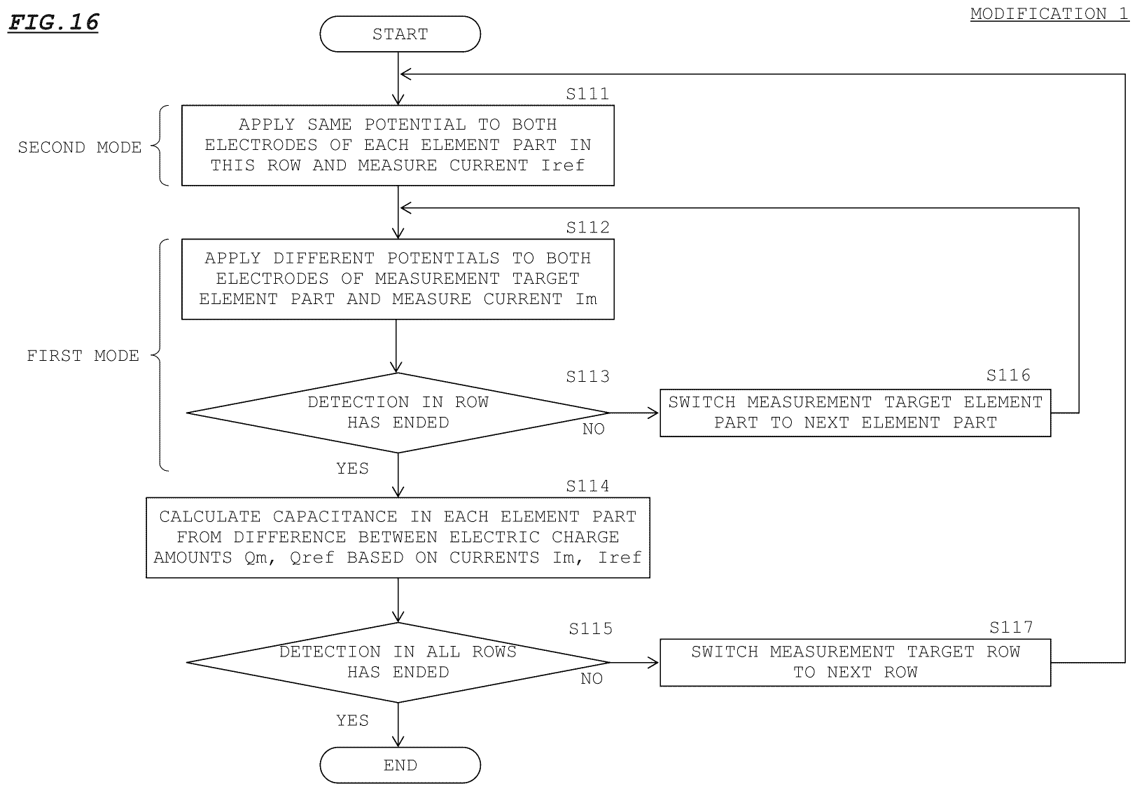

FIG. 16 is a flowchart showing a capacitance detection process according to Modification 1.

In FIG. 16, step S111 corresponds to the measurement process based on the potential in the second mode described above, and steps S112, S113, S116 correspond to the measurement process based on the potential in the first mode described above.

In the period T1 in FIG. 12, the controller 300 causes the same potential (the power supply potential Vdd) to be simultaneously applied to both electrodes of all the element parts included in the row serving as the measurement target, to measure the current Iref being common between these element parts (S111). That is, in step S111, the controller 300 sets the first switchover part 120 and the second switchover part 130 such that the same potential (the power supply potential Vdd) is simultaneously applied to both ends of all the element parts in the row serving as the measurement target, and in the period T1 in FIG. 12 arriving thereafter, causes the same potential (the power supply potential Vdd) to be applied to both electrodes of the element part serving as the measurement target. From the current Iref measured by the current measurer 200 in this period T1, the controller 300 calculates the average current Iref_av in the period T1, and acquires the electric charge amount Qref from the calculated Iref_av.

Next, the controller 300 causes, out of the plurality of element parts included in the row serving as the measurement target, the element part serving as the measurement target for which different potentials are applied to both electrodes, to be sequentially switched, to measure the current Im for each element part serving as the measurement target (S112, S113, S116). That is, in step S112, the controller 300 sets the first switchover part 120 and the second switchover part 130 such that different potentials (the power supply potential Vdd, the ground potential) are applied to both electrodes of the element part serving as the measurement target, and in the next period T1 in FIG. 12, causes different potentials (the power supply potential Vdd, the ground potential) to be applied to both electrodes of the element part serving as the measurement target. From the current Im measured by the current measurer 200 in this period T1, the controller 300 calculates the average current Im_av in the period T1.

In step S116, the controller 300 causes the measurement target to be switched to the next element part in the row serving as the measurement target. In step S112, in the next period T1, the controller 300 acquires the current Im from the current measurer 200 and calculates the average current Im_av with respect to the element part. The controller 300 sequentially performs this process with respect to all the element parts in the row serving as the measurement target (S113).

Then, when the process with respect to all the element parts in the row serving as the measurement target has ended (S113: YES), the controller 300 calculates the capacitance in each element part in this row from the difference between the electric charge amounts Qm, Qref based on the currents Im, Iref (S114). Specifically, the controller 300 applies the common average current Iref_av acquired in step S111 and the average current Im_av with respect to each element part acquired in step S112 to Formulas (1), (1-1), (1-2) above for each element part, to calculate the capacitance in each element part in the row serving as the measurement target.

Then, when the detection of the capacitance with respect to this row has ended, the controller 300 determines whether or not the detection of the capacitance has ended with respect to all the rows included in the load sensor 1 (S115). When the determination in step S115 is NO, the controller 300 causes the row serving as the measurement target to be switched to the next row (S117), and executes the processes in step S111 and thereafter. Accordingly, the capacitance in each element part in the next row is detected. Until the process is executed with respect to all the rows (S115: NO), the controller 300 causes the row serving as the measurement target to be sequentially switched (S117), to repeatedly execute the processes in step S111 and thereafter. Then, when the capacitance has been detected with respect to the element parts in all the rows (S115: YES), the controller 300 ends the process in FIG. 16.

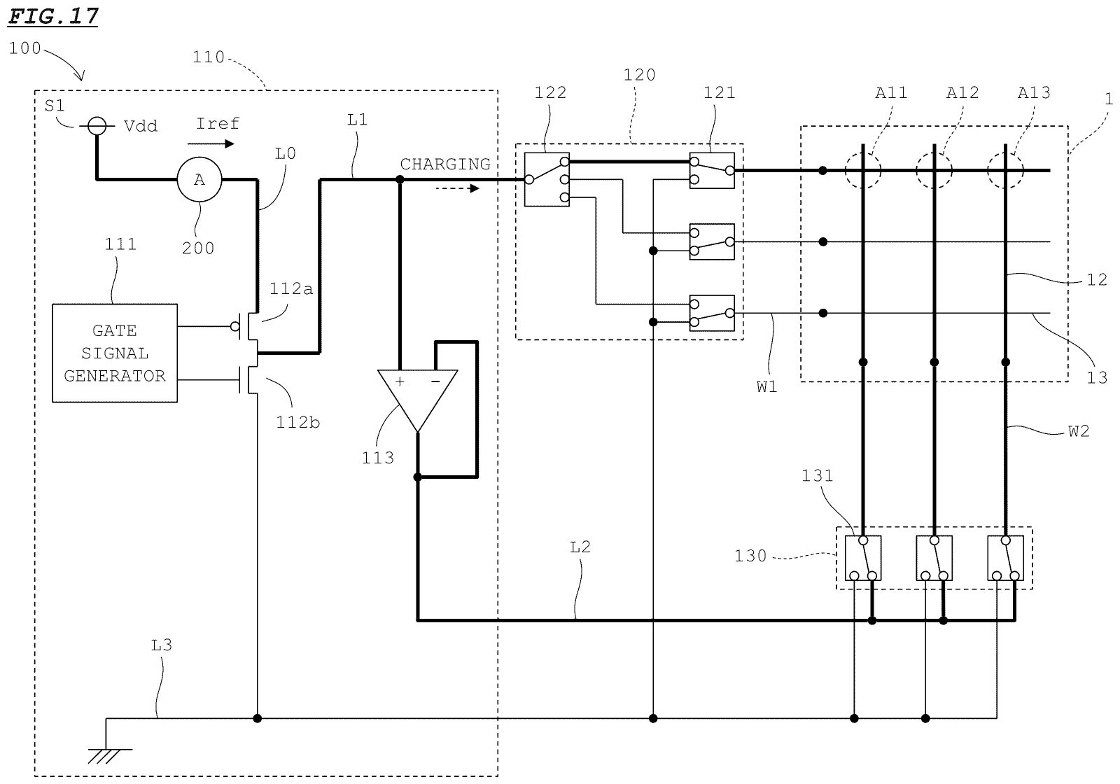

FIG. 17 schematically shows a potential application state with respect to each element part in the row serving as the measurement target when step S111 (the second mode) in FIG. 16 is executed.

Here, the row serving as the measurement target is set to the uppermost row, and the element part serving as the measurement target is set to the element part A11. In the three element parts included in the uppermost row, the power supply potential Vdd is applied to one electrode, and the potential from the equipotential generator 113 is applied to the other electrode. The controller 300 calculates the average current Iref_av from the current Iref measured by the current measurer 200, in the period T1 in which this state is formed.

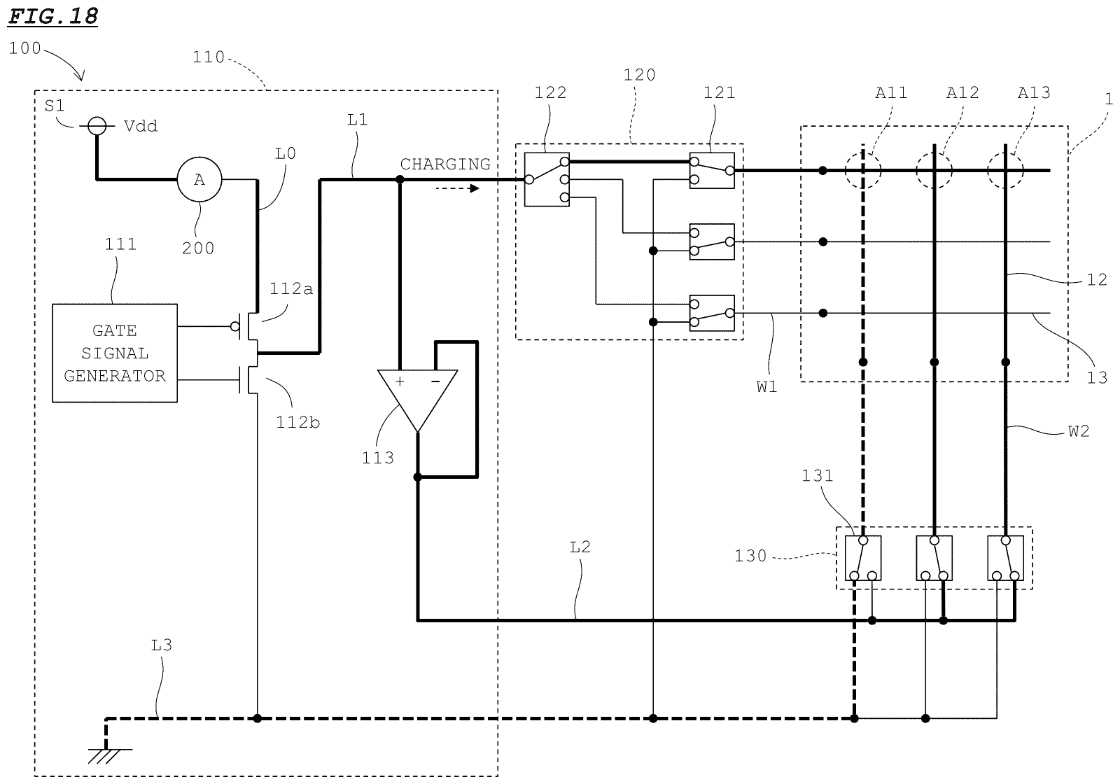

FIG. 18 schematically shows a potential application state with respect to each element part in the row serving as the measurement target when step S112 (the first mode) in FIG. 16 is executed.

Similar to Embodiment 1 above, discharging operation is performed in the period T2 in FIG. 7, between the second mode in FIG. 17 and the first mode in FIG. 18. The setting states of the first switchover part 120 and the second switchover part 130 during the discharging operation are the same as the setting states in FIG. 17.

As shown in FIG. 18, out of the three element parts in the uppermost row, only in the element part A11 serving as the measurement target, are different potentials applied to both electrodes. The controller 300 calculates the average current Im_av with respect to the element part A11 from the current Im measured by the current measurer 200, in the period T2 in which this state is formed.

In the next period T2, the controller 300 performs the same discharging operation as the above. Then, before the next period T1 arrives, the controller 300 sets the second switchover part 130 such that the ground potential is applied to the electrode (the electrically-conductive elastic body 12) in the center column. Then, in the next period T1, the controller 300 calculates the average current Im_av with respect to the element part A12. The controller 300 calculates the average current Im_av in the element part A13 through the same process.

As a result, the determination in step S113 in FIG. 16 becomes YES. In step S114, from the common average current Iref_av and average current Im_av respectively acquired with respect to the element parts A11, A12, A13, the controller 300 calculates the respective capacitances in these element parts A11, A12, A13 by Formulas (1), (1-1), (1-2) above. The controller 300 performs the same process with respect to the other rows. Accordingly, the capacitance is calculated with respect to all the element parts.

With Modification 1 as well, effects similar to those of Embodiment 1 above can be exhibited.

As shown in FIG. 16, the controller 300, in the second mode, causes the same potential to be simultaneously applied to both ends of all the element parts included in the row serving as the measurement target, and acquires the electric charge amount Qref (the second value) being common between these element parts (S111), and in the first mode, causes, out of the plurality of element parts included in the row serving as the measurement target, the element part serving as the measurement target for which different potentials are applied to both electrodes thereof, to be sequentially switched (S116), acquires the electric charge amount Qm (the first value) for each element part serving as the measurement target (S112, S113), and detects the capacitance in each element part from the difference between the electric charge amount Qm (the first value) in each element part and the common electric charge amount Qref (the second value) (S114). With this process, the electric charge amounts Qref (the second value) are acquired in a batch with respect to the element parts in one row, and thus, the capacitance detection process with respect to each element part can be performed quickly and in a simple manner.

In the flowchart in FIG. 16, after the measurement of the current Iref in the second mode (step S111) has been performed, the measurement of the current Im for each element part in the first mode (steps S112, S113, S116) is performed. However, after the measurement of the current Im for each element part in the first mode (steps S112, S113, S116) has been performed, the measurement of the current Im in the second mode (step S111) may be performed.

In FIG. 16, step S114 may be moved to be between step S112 and step S113, and every time the measurement of the current Im with respect to the element part serving as the measurement target is performed in step S112, the capacitance in the element part serving as the measurement target may be calculated. Alternatively, the process in step S114 may be moved to be after step S115, and after the process with respect to all the rows has ended, calculation of the capacitance with respect to each element part may be performed.

### Modification 2

In Embodiment 1 above, as the electric quantity which changes due to charging of electric charge with respect to the element part, the current flowing in the charging path between one electrode (the conductor wire 13) and the power supply S1 is measured. In contrast, in Modification 2, as the electric quantity which changes due to discharging of electric charge with respect to the element part, the current flowing in the discharging path between one electrode (the conductor wire 13) and the ground line L3 is measured.

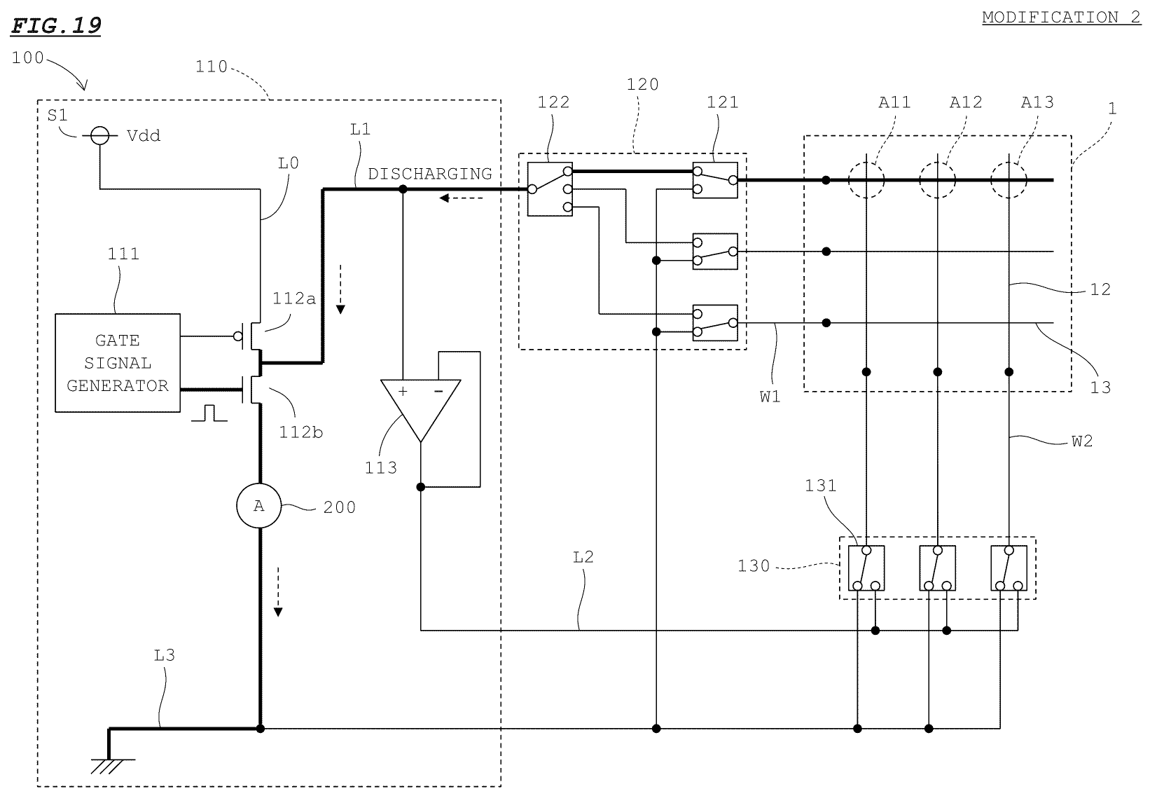

FIG. 19 is a circuit diagram showing a configuration of the potential applier 100 according to Modification 2.

As shown in FIG. 19, in Modification 2, the current measurer 200 is disposed between the switching element 112b and the ground line L3. The current measurer 200 measures the current (the currents Im, Iref) flowing from the switching element 112b to the ground line L3 during discharging shown in FIG. 19, i.e., in the period T2 in FIG. 7. The controller 300 calculates the average current (the average currents Im_av, Iref_av) in the period T2 from the measured current and calculates the capacitance C in each element part from Formula (2) below. Formula (2) is the same as Formula (1) above. In Formulas (2-1), (2-2), T1 in Formulas (1-1), (1-2) above has been changed to T2.

$$C = ( Qm - Qref ) / Vdd \qquad ( 2 )$$

$$Qm = Im\_av \cdot T 2 \qquad ( 2 - 1 )$$

$$Qref = Iref\_av \cdot T 2 \qquad ( 2 - 2 )$$

The capacitance detection process with respect to each element part is the same as the detection process in FIG. 14 except that measurement of the current (the currents Im, Iref) is performed during discharging operation (the period T2). That is, in step S101 (the first mode), application of different potentials is performed in the period T1, and measurement of the current Im is performed in the period T2 that appears subsequently to the period T1. In step S102 (the second mode), application of the same potential is performed in the period T1 that appears subsequently to the period T2, and measurement of the current Iref is performed in the period T2 that appears subsequently to the period T1.

Similar to Embodiment 1 above, the order of the first mode (step S101) and the second mode (steps S102, S103, S106) may be reversed. The capacitance detection process with respect to each element part may be the process in FIG. 16 according to Modification 1 above. In this case as well, in the second mode (step S111), charging with respect to each element part in the row serving as the measurement target is performed through application of the potential in the period T1, and during discharging in the next period T2, measurement of the current Iref is performed. In the first mode (steps S112, S113, S116), charging with respect to the element part serving as the measurement target in the row serving as the measurement target is performed through application of the potential in the next period T1, and during discharging in the next period T2, measurement of the current Im is performed. In this case as well, the order of the second mode (step S111) and the first mode (steps S112, S113, S116) may be reversed.

In Modification 2 as well, effects similar to those of Embodiment 1 above are exhibited.

That is, as shown in FIG. 19, as the electric quantity which changes due to discharging of electric charge with respect to the element part, the current measurer 200 measures the current flowing in the discharging path between one electrode (the conductor wire 13) and the ground line L3 during potential application. Accordingly, the currents Im, Iref according to the electric charge amount in the element part serving as the measurement target and the electric charge amount of the other unnecessary capacitance can be measured. Therefore, from the difference between the electric charge amounts Om and Qref based on these currents Im, Iref, the capacitance in the element part serving as the measurement target can be appropriately acquired.

The controller 300 acquires the electric charge amount Om (the first value) until completion of discharging, from the current Im measured by the current measurer 200 in the first mode, acquires the electric charge amount Qref (the second value) until completion of discharging, from the current Iref measured by the current measurer 200 in the second mode, and calculates the capacitance in the element part serving as the measurement target, from the electric charge amounts Om, Qref and the potential difference V between different potentials, by Formulas (2), (2-1), (2-2) above. Accordingly, the capacitance in the element part serving as the measurement target can be accurately acquired.

### Modification 3

In Embodiment 1 above, the plurality of element parts are disposed in a matrix shape, but the number and the disposition of the element parts are not limited thereto.

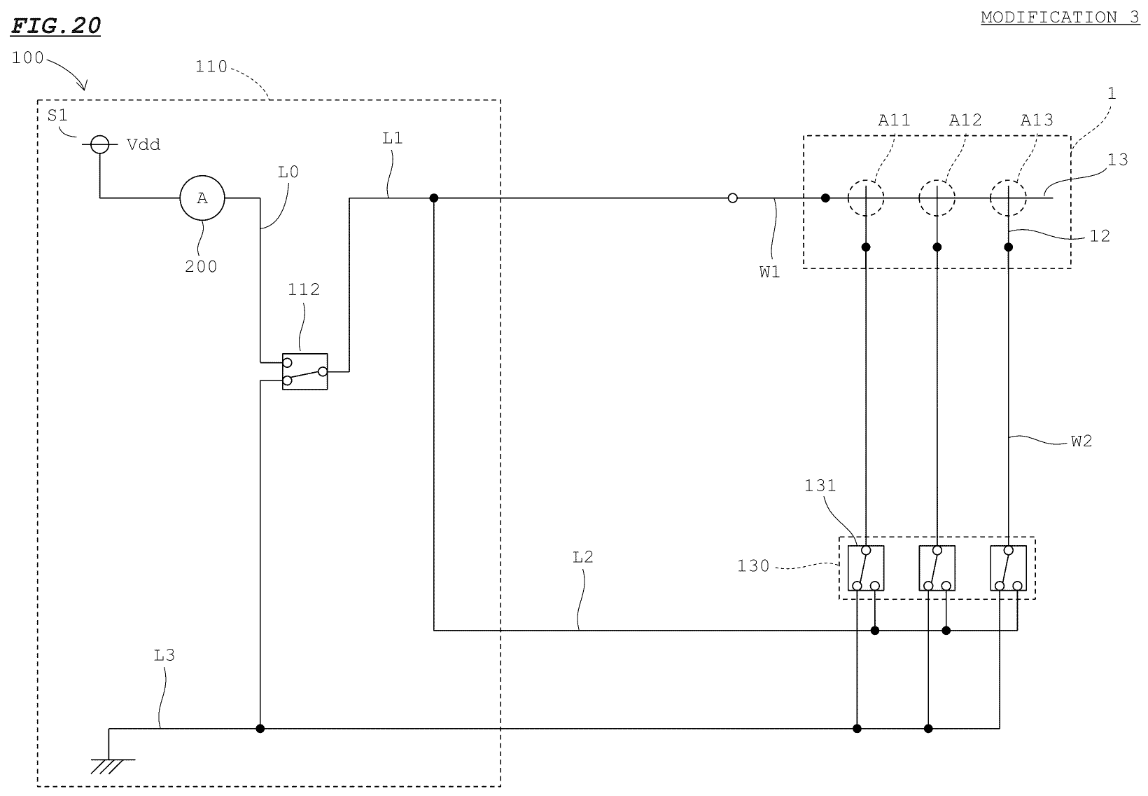

FIG. 20 is a circuit diagram showing a configuration of the load sensor 1 and the potential applier 100 according to Modification 3.

In Modification 3, the load sensor 1 includes three element parts A11 to A13 only. The three element parts A11 to A13 are arranged in one row. That is, the load sensor 1 includes one conductor wire 13 and three electrically-conductive elastic bodies 12.

In this configuration, there are no element parts of the second row and the third row in the load sensor 1, and thus, for example, it is not necessary to supply a current from the equipotential generator 113 to the other two element parts in the same column as that of the element part A11, unlike the case of FIG. 10. Therefore, as shown in FIG. 20, the equipotential generator 113 can be omitted, and the power supply potential Vdd in the supply line L1 can be directly applied to each element part via the supply line L2.

In the configuration in FIG. 20, as a configuration for selectively connecting the supply line L1 to the supply line L0 or the ground line L3, a multiplexer 112 is used. The multiplexer 112 is switched through control from the controller 300. The multiplexer 112 is connected to the supply line L0 side in the period T1 and is connected to the ground line L3 side in the period T2.

In Embodiment 1 above as well, the multiplexer 112 may be used instead of the switching elements 112a, 112b as in FIG. 20. The element for selectively connecting the supply line L1 to the supply line L0 or the ground line L3 is not limited to the switching elements 112a, 112b or the multiplexer 112, and may be another switch such as a mechanical switch.

In the configuration of Modification 3, steps S105, S107 in FIG. 14 are omitted, and steps S115, S117 in FIG. 16 are omitted. In this case as well, the order of the process (the first mode) in step S101 and the process (the second mode) in steps S102, S103, S106 in FIG. 14 may be reversed, and the order of the process (the second mode) in step S111 and the process (the first mode) in steps S112, S113, S116 in FIG. 16 may be reversed.

In the configuration of Modification 3 as well, as in Modification 2 shown in FIG. 19, the current measurer 200 may be disposed between the multiplexer 112 and the ground line L3 and measure the current during discharging. In this case as well, as in Modification 2 above, the capacitance in each element part is calculated by Formula (2) above.

The element parts A12, A13 may be further omitted from the configuration in FIG. 20, and the second switchover part 130 may include only the multiplexer 131 corresponding to the element part A11. In this case, the currents Im, Iref are measured with respect to the element part A11, and the capacitance in the element part A11 is calculated by Formula (1) or Formula (2) above.

### Embodiment 2

In Embodiment 1 above, as the electric quantity which changes due to charging or discharging of electric charge with respect to the element part, the current flowing in the path between one electrode (the conductor wire 13) of the element part and the power supply S1 is measured. In contrast, in Embodiment 2, as the electric quantity which changes due to charging or discharging of electric charge with respect to the element part, the voltage in the element part is measured.

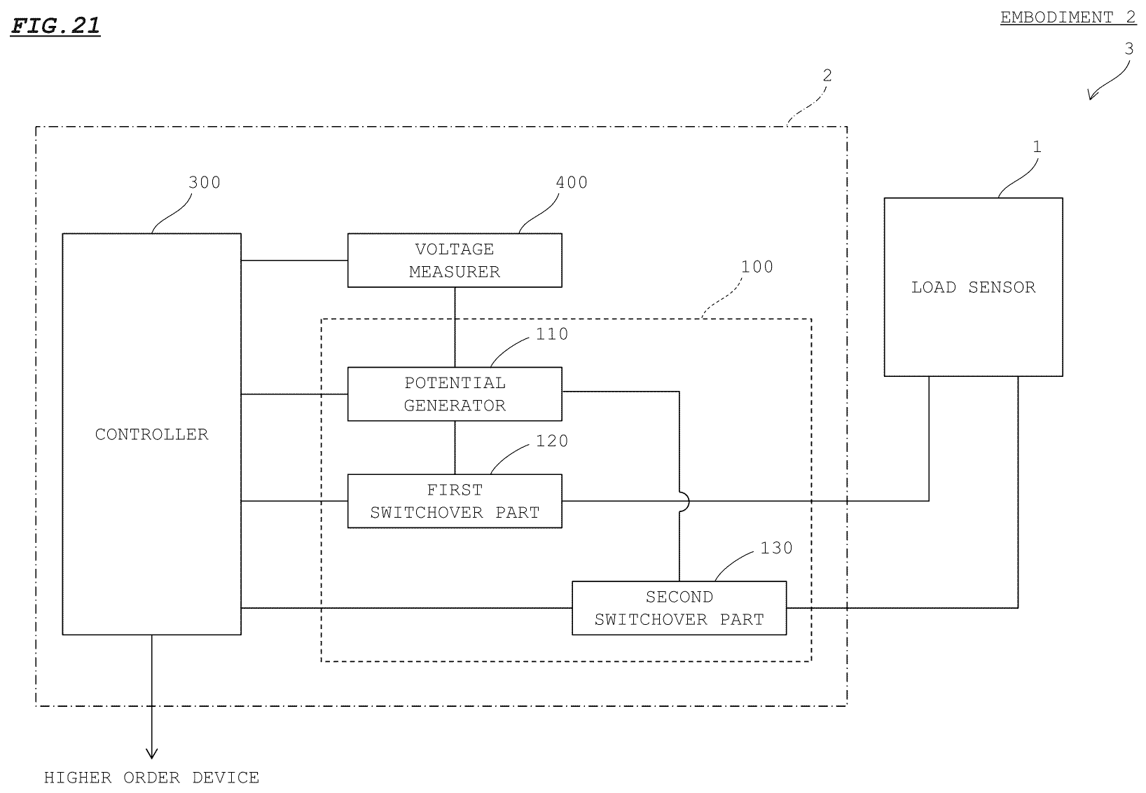

FIG. 21 is a block diagram showing a configuration of the load detecting device 3 according to Embodiment 2.

As shown in FIG. 21, in Embodiment 2, instead of the current measurer 200 in FIG. 5, a voltage measurer 400 for measuring the voltage in the element part is disposed in the detecting circuit 2.

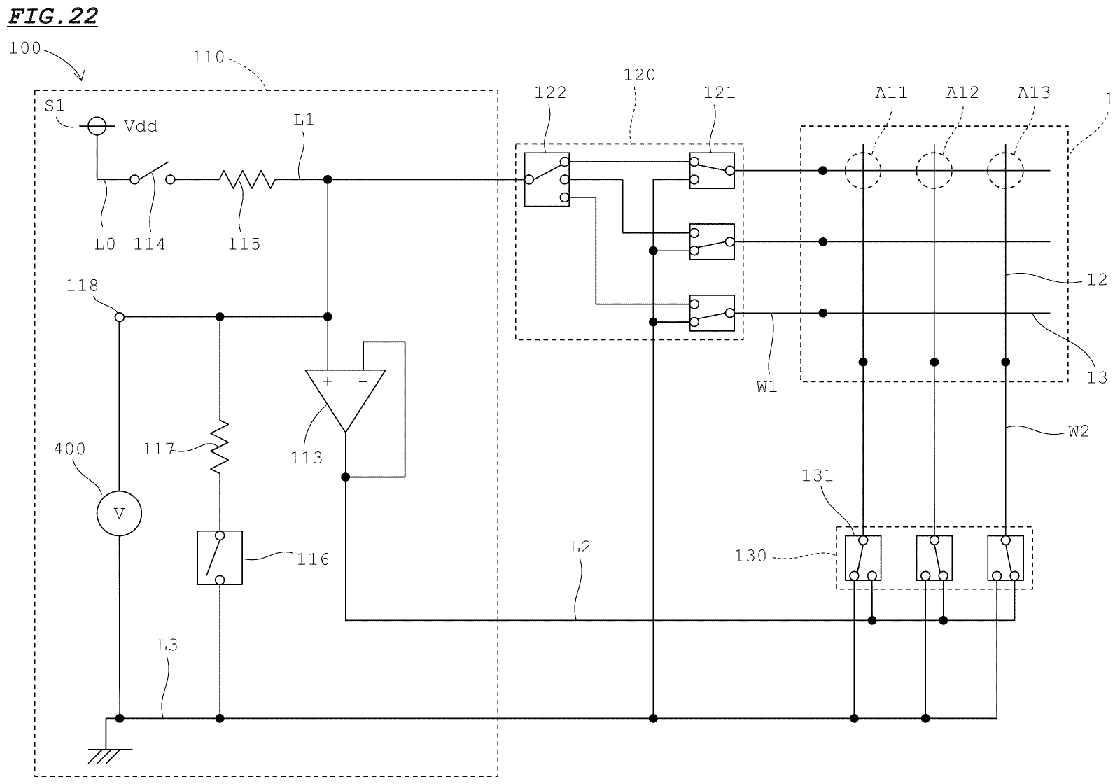

FIG. 22 is a circuit diagram showing a configuration of the potential applier 100 according to Embodiment 2.

In FIG. 22, for convenience, in order to show that the voltage measurer 400 measures the voltage (the voltage in the element part) between the supply line L0 and the ground line L3, the voltage measurer 400 is included in the broken line frame showing the potential generator 110, for convenience.

In the configuration in FIG. 22, the gate signal generator 111, the switching elements 112a, 112b, and the current measurer 200 are omitted from the configuration in FIG. 6, and a switch 114, a resistor 115, a switch 116, a resistor 117, and the voltage measurer 400 are added.

The switch 114 selectively connects the supply line L0 having the power supply potential Vdd and the resistor 115 to each other. The switch 116 and the resistor 117 form a discharging path for discharging electric charge accumulated in the element part. During discharging, the switch 116 is closed. Accordingly, electric charge accumulated in the element part is discharged to the ground line L3. The voltage measurer 400 measures the voltage (the voltage in the element part) between the supply line L0 and the ground line L3. The voltage measurer 400 may be an A/D converter that converts the potential at an output terminal 118 into a digital signal and outputs the digital signal to the controller 300.

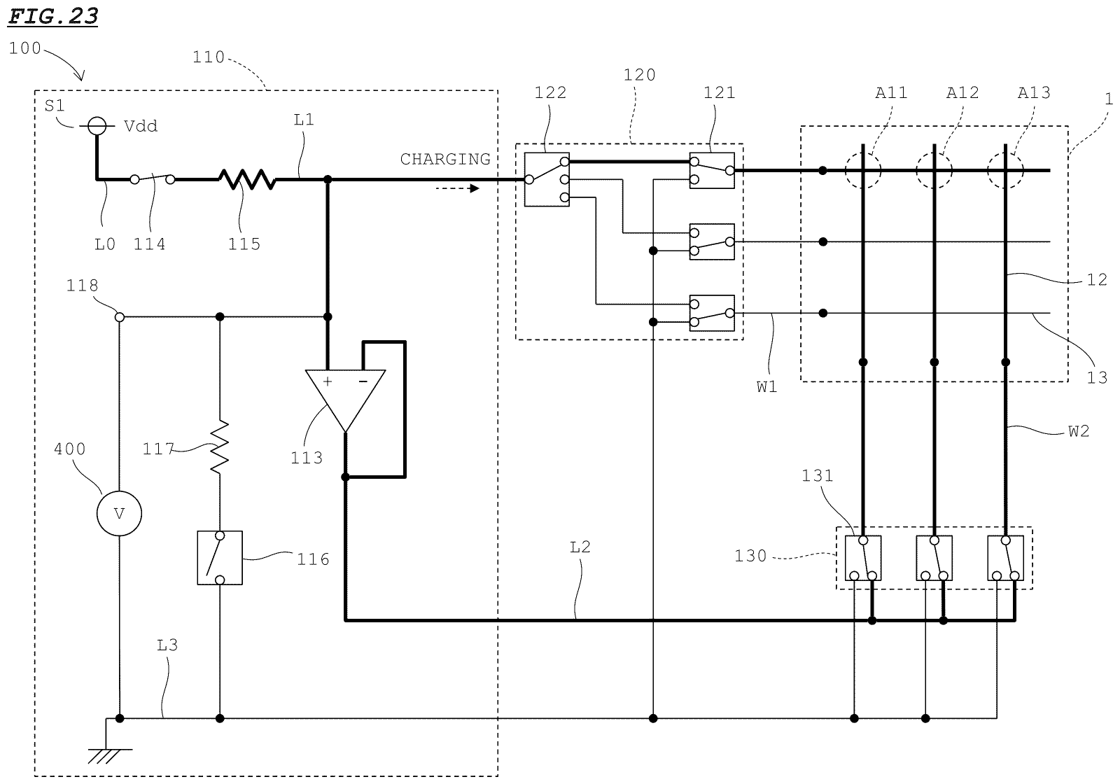

FIG. 23 shows an operation state of the potential applier 100 in the second mode in which the same potential is applied to both electrodes of the element part A11 serving as the measurement target. In FIG. 23, the thick solid line indicates the path along which a potential equivalent to the power supply potential Vdd is applied.

After performing discharging operation with respect to the load sensor 1, the controller 300 closes the switch 114 for a certain period to cause the power supply potential Vdd to be applied to the circuitry on the subsequent stage side of the switch 114. Accordingly, the power supply potential Vdd is applied to one electrode (the conductor wire 13) of each of the three element parts A11 to A13, and a potential similar to the power supply potential Vdd is applied to the other electrode (the electrically-conductive elastic body 12) from the equipotential generator 113. The controller 300 acquires a voltage Vref measured by the voltage measurer 400, at a predetermined timing after the switch 114 has been closed.

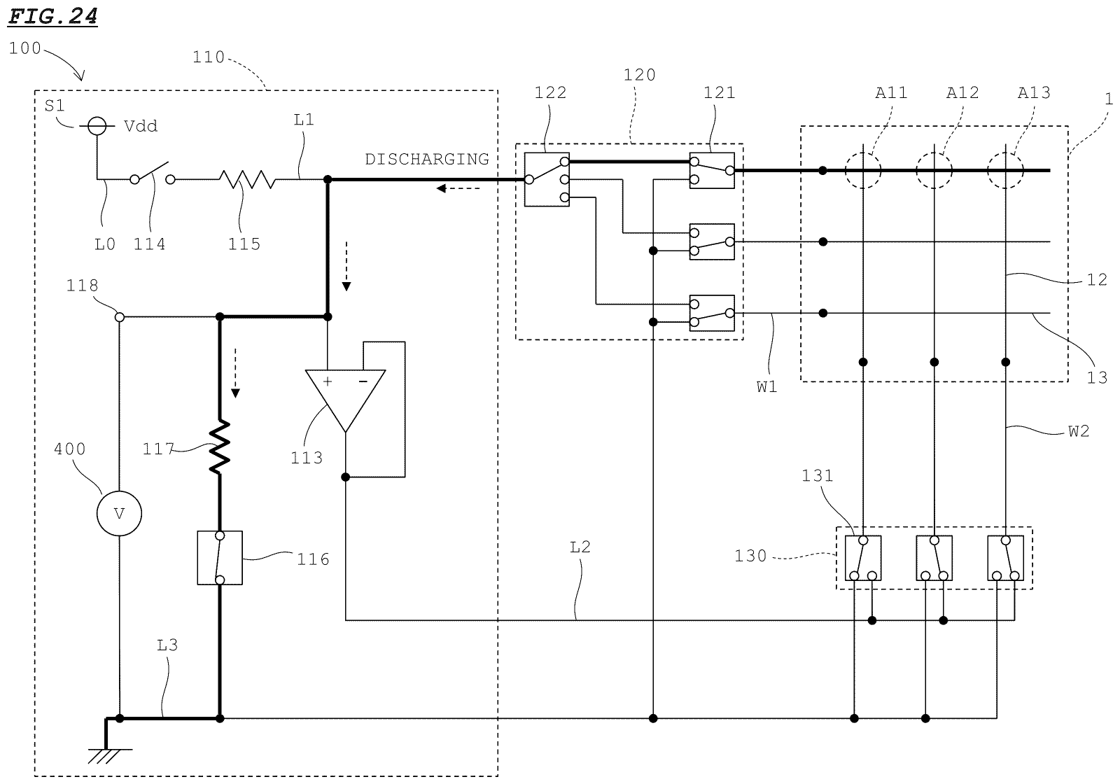

FIG. 24 shows an operation state of the potential applier 100 when electric charge charged through operation in FIG. 23 is discharged. In FIG. 24, the thick solid line indicates the discharging path of electric charge.

After opening the switch 114, the controller 300 closes the switch 116 for a certain period. Accordingly, electric charge accumulated in the element parts A11 to A13 is discharged.

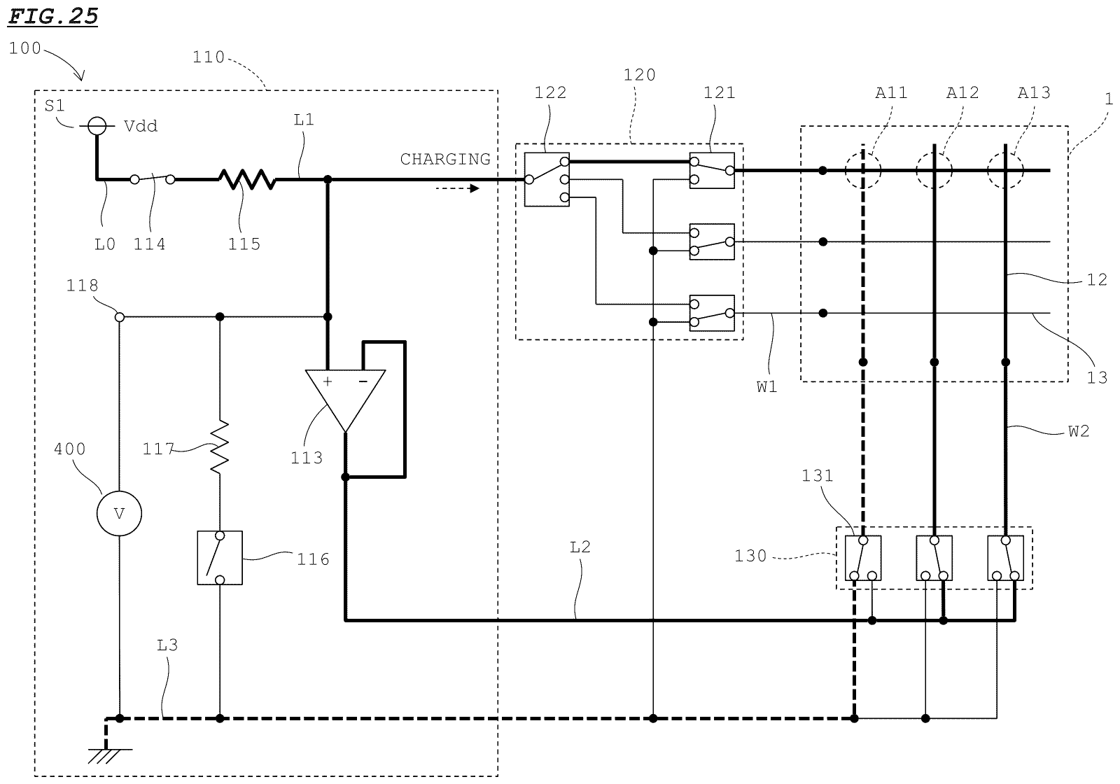

FIG. 25 shows an operation state of the potential applier 100 in the first mode in which different potentials are applied to both electrodes of the element part A11 serving as the measurement target. In FIG. 25, the thick solid line indicates the path along which a potential equivalent to the power supply potential Vdd is applied, and the thick broken line indicates the path along which the ground potential is applied.

After the discharging in FIG. 24, the controller 300 opens the switch 116, and switches the connection destination of the leftmost multiplexer 131 of the second switchover part 130 to the terminal on the ground line L3 side, to close the switch 114. Accordingly, in the element part A11, the power supply potential Vdd is applied to one electrode (the conductor wire 13), and the ground potential is applied to the other electrode (the electrically-conductive elastic body 12), and in the element parts A12, A13, the power supply potential Vdd is applied to one electrode (the conductor wire 13), and a potential similar to the power supply potential Vdd is applied to the other electrode (the electrically-conductive elastic body 12) from the equipotential generator 113. The controller 300 acquires a voltage Vm measured by the voltage measurer 400, at a predetermined timing after the switch 114 has been closed. Then, the controller 300 opens the switch 114 and closes the switch 116, and performs discharging with respect to the load sensor 1.

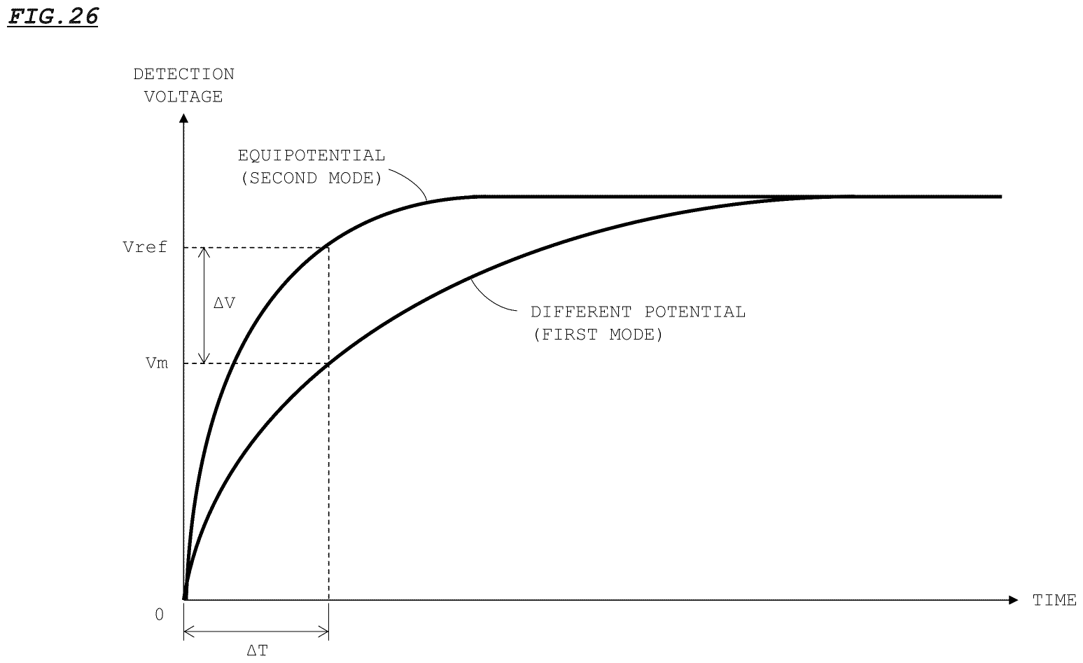

FIG. 26 schematically shows change in voltage measured by the voltage measurer 400 during operation in FIG. 23 and FIG. 25.

As shown in FIG. 26, when different potentials are applied to the element part serving as the measurement target, the time until establishment of conversion to the power supply potential Vdd becomes long, as compared with a case where the same potential is applied. Therefore, as for the voltages Vm, Vref measured by the voltage measurer 400 at a timing after a certain time ΔT after potential application, the voltage Vm become smaller than the voltage Vref.

The controller 300 calculates the capacitance C in the element part serving as the measurement target from a difference ΔV between the voltage Vm and the voltage Vref, by Formula (3) below. R in Formula (3) is the resistance value of the resistor 115.

$$Δ V = Vdd \cdot ( 1 - {e}^{- \frac{1}{CR} Δ t} ) \qquad ( 3 )$$

The detection of the capacitance with respect to each element part is performed according to a process similar to that in FIG. 14 or FIG. 16. In Embodiment 2, measurement of the currents Im, Iref in the process in FIG. 14 and FIG. 16 is replaced with measurement of the voltages Vm, Vref. In addition, the calculation of the capacitance in steps S104, 114 is performed by Formula (3) above. As in the case of Embodiment 1 and Modification 1 above, the order of acquiring the voltage Vm and the voltage Vref may be reversed. As in Modification 2 above, the voltages Vm, Vref may be acquired during discharging operation. In this case, R in Formula (3) is the resistance value of the resistor 117.

### Effects of Embodiment 2

In Embodiment 2 as well, the voltage Vm includes the electric charge amount in the element part serving as the measurement target, and in addition, influence of the unnecessary electric charge amount accumulated in the element parts other than the measurement target and the parasitic capacitance. The voltage Vref includes influence of, mainly, the unnecessary electric charge amount accumulated in the element parts other than the measurement target and the parasitic capacitance. Therefore, when the capacitance in the element part serving as measurement target is calculated based on the temporal change in the difference ΔV between the voltages Vm and Vref by using Formula (3) above, it is possible to suppress the unnecessary electric charge amount accumulated in the element parts other than the measurement target and the parasitic capacitance from influencing the result of the detection of the capacitance. Therefore, the accuracy of the calculation result of the capacitance can be enhanced as compared with a case where the capacitance is calculated by using the voltage Vm only.

However, in Embodiment 2, as shown in FIG. 26, the voltages Vm, Vref are acquired at a timing before accumulation of electric charge is saturated, i.e., at a timing while the current and the voltage are changing. Therefore, the acquired voltages Vm, Vref can include influence of parasitic inductance and parasitic impedance. Therefore, the capacitance calculated from these voltages Vm, Vref can include an error component, as compared with Embodiment 1 above. Therefore, in order to more accurately acquire the capacitance, it is preferable to acquire the capacitance of the measurement target by using the currents Im, Iref according to the electric charge amount in a state where accumulation of electric charge with respect to the element part has been saturated, as in Embodiment 1 above.

### Other Modifications

In Embodiments 1, 2 above, in the first switchover part 120, the multiplexer 122 is disposed in the preceding stage of the three multiplexers 121. However, the multiplexer 122 may be omitted and the supply line L1 may be directly connected to one input terminal of each of the three multiplexers 121. Then, the influence of parasitic capacitance and the like that occurs due to the multiplexer 122 can be suppressed. However, in this case, at the time of acquisition of the currents Im, Iref, the power supply potential Vdd is applied to all of the three multiplexers 121. Therefore, influence of parasitic capacitance and the like of the multiplexer 121 connected to the row other than the row serving as the measurement target can be assumed. It is preferable that the first switchover part 120 is configured such that the equivalent capacitance viewed from the supply line L1 is as small as possible.

In Embodiment 1 above, the current measurer 200 measures the current flowing in the supply line L0, but the current measurer 200 may measure the current at another position on the path between one electrode (the conductor wire 13) of the element part and the power supply S1. Similarly, in Modification 2 in FIG. 19 as well, the current measurer 200 may be disposed so as to detect the current at another position on the path between one electrode (the conductor wire 13) and the ground line L3 during discharging.

In Embodiment 1 above, the electric charge amounts Qm, Qref are calculated by multiplying the average currents Im_av, Iref_av by the period T1. However, the method of obtaining the electric charge amounts Om, Qref is not limited thereto. For example, when the average currents Im_av, Iref_av are calculated with respect to the cycle TO, the electric charge amounts Qm, Qref may be calculated by multiplying the average currents Im_av, Iref_av by the cycle TO. Alternatively, the electric charge amounts Om, Qref may be calculated by dividing the average currents Im_av, Iref_av by a frequency FO in the cycle TO, instead of multiplying by the cycle TO. Alternatively, the electric charge amounts Om, Qref may be acquired by integrating the currents Im, Iref for the period T1.

In Embodiments 1, 2 above, the first switchover part 120 and the second switchover part 130 are implemented by the multiplexers 121, 122, 131. However, the first switchover part 120 and the second switchover part 130 may be implemented by a switchover circuit other than the multiplexer.

In Embodiments 1, 2 above, the conductor wire 13 is implemented by a covered copper wire, but not limited thereto, may be composed of a linear-shaped electrically-conductive member formed from a substance other than copper and a dielectric body covering the electrically-conductive member. The electrically-conductive member may be implemented by a twisted wire.

In Embodiments 1, 2 above, the electrically-conductive elastic bodies 12 are provided only on the face on the Z-axis positive side of the base member 11. However, electrically-conductive elastic bodies may be provided also on the face on the Z-axis negative side of the base member 15. In this case, the electrically-conductive elastic bodies on the base member 15 side are configured similarly to the electrically-conductive elastic bodies 12 on the base member 11 side, and are disposed so as to overlap the electrically-conductive elastic bodies 12 so as to sandwich the conductor wires 13 therebetween in a plan view. Then, the cables drawn from electrically-conductive elastic bodies on the base member 15 side are connected to the wiring cables W2 drawn from the electrically-conductive elastic bodies 12 opposing in the Z-axis direction. When the electrically-conductive elastic bodies are provided above and below the conductor wires 13 in this manner, change in the capacitance in each element part becomes approximately twice correspondingly to the upper and lower electrically-conductive elastic bodies. Therefore, the detection sensitivity of the load applied to the element part can be enhanced.

In Embodiments 1, 2 above, the dielectric body 13b is formed on the electrically-conductive member 13a so as to cover the outer periphery of the electrically-conductive member 13a. However, instead of this, the dielectric body 13b may be formed on the upper face of the electrically-conductive elastic body 12. In this case, in accordance with application of the load, the electrically-conductive member 13a sinks in and is wrapped by the dielectric body 13b and the electrically-conductive elastic body 12, and the contact area between the electrically-conductive member 13a and the electrically-conductive elastic body 12 changes. Accordingly, similar to the embodiments above, the load applied to each element part can be detected.

In Embodiments 1, 2 above, each element part is formed by the electrically-conductive elastic body 12 and the conductor wire 13 crossing each other. However, the configuration of the element part is not limited thereto. For example, the element part may be formed by a hemisphere-shaped electrically-conductive elastic body and a flat-plate-shaped electrode sandwiching a dielectric body. In this case, the dielectric body may be formed on the surface of the electrode opposing the electrically-conductive elastic body, or may be formed on the surface of the hemisphere-shaped electrically-conductive elastic body.

In addition, the detecting circuit according to the present invention can be used as appropriate not only in the load sensor but also when the capacitance is detected from an element part having certain capacitance of, for example, a ceramic capacitor, an electrolytic capacitor, or a capacitive element formed in an electrostatic touch panel or a semiconductor device.

In addition to the above, various modifications can be made as appropriate to the embodiments of the present invention without departing from the scope of the technical idea defined by the claims.

### (Additional Note)

The following technologies are disclosed by the description of the embodiments above.

### (Technology 1)

A load detecting device comprising:
a load sensor including an element part in which capacitance changes in accordance with a load; and
a detecting circuit configured to detect capacitance in the element part, wherein
the detecting circuit includes
   a potential applier configured to apply a predetermined potential to both electrodes of the element part,
   a measurer configured to measure an electric quantity which changes due to charging or discharging of electric charge with respect to the element part, and
   a controller, and
the controller
   acquires a first value from the electric quantity measured in the first mode in which potentials applied to the both electrodes are different from each other,
   acquires a second value from the electric quantity measured in a second mode in which potentials applied to the both electrodes are identical, and
   detects capacitance in the element part, from a difference between the first value and the second value.

According to this technology, the difference between the first value and the second value is a value in which influence of parasitic capacitance, parasitic inductance, and the like is canceled from the first value, and mainly reflects the electric charge amount accumulated in the element part. Therefore, when the capacitance in the element part is detected from this difference, capacitance in which influence of parasitic capacitance, parasitic inductance, and the like is effectively suppressed can be acquired. Therefore, the detection accuracy of the load applied to the element part can be enhanced. In addition, for detection of the capacitance, it is not necessary to separately provide a special circuit, and it is sufficient that the potential to be applied to both electrodes of the element part is switched as described above. Therefore, the capacitance in the element part can be accurately detected with a simple configuration.

### (Technology 2)

The load detecting device according to technology 1, wherein
the measurer measures, as the electric quantity, a current flowing in a charging path in the potential applier.

According to this technology, in the first mode and the second mode, the current according to the electric charge amount in the element part and the electric charge amount of the other unnecessary capacitance can be measured. Therefore, from the difference between these currents, the capacitance in the element part serving as the measurement target can be appropriately acquired.

### (Technology 3)

The load detecting device according to technology 1, wherein
the measurer measures, as the electric quantity, a current flowing in a discharging path in the potential applier.

According to this technology, as in technology 2, in the first mode and the second mode, the current according to the electric charge amount in the element part and the electric charge amount of the other unnecessary capacitance can be measured. Therefore, from the difference between these currents, the capacitance in the element part serving as the measurement target can be appropriately acquired.

### (Technology 4)

The load detecting device according to technology 2 or 3, wherein
the controller
   acquires, as the first value, an electric charge amount Qm until completion of the charging or the discharging, from a current Im measured by the measurer in the first mode,
   acquires, as the second value, an electric charge amount Qref until completion of the charging or the discharging, from a current Iref measured by the measurer in the second mode, and
   calculates the capacitance in the element part from the electric charge amounts Om, Qref and a potential difference V between the different potentials, by a relational expression below.

$$C = ( Qm - ( Qref ) / V$$

According to this technology, the capacitance in the element part serving as the measurement target can be accurately acquired by the formula above.

### (Technology 5)

The load detecting device according to technology 1, wherein
the measurer measures, as the electric quantity, a voltage in the element part.

According to this technology, in the first mode and the second mode, the voltage according to the electric charge amount in the element part and the electric charge amount of the other unnecessary capacitance can be measured. Therefore, from the difference between these voltages, the capacitance in the element part serving as the measurement target can be appropriately acquired.

### (Technology 6)

The load detecting device according to technology 5, wherein
the controller detects the capacitance in the element part, based on temporal change in a difference ΔV between the voltage, which is denoted by Vm, measured by the measurer in the first mode, and the voltage, which is denoted by Vref, measured by the measurer in the second mode.

According to this technology, the capacitance in the element part serving as the measurement target can be accurately acquired.

### (Technology 7)

The load detecting device according to any one of technologies 1 to 6, wherein
the load sensor comprises a plurality of the element parts,
the potential applier is configured to be able to switch the element part to which the potential is applied, and
in the first mode and the second mode, the controller controls the potential applier to apply the potential to each of the element parts, acquires, from the measurer, the electric quantity with respect to each of the element parts, and detects the capacitance with respect to each of the element parts from the first value and the second value based on the acquired electric quantity in each of the element parts.

According to this technology, since a plurality of the element parts are disposed, the load detection range can be expanded. Since the above process is executed with respect to each element part, the capacitance applied to each element part can be accurately detected.

### (Technology 8)

The load detecting device according to technology 7, wherein
the plurality of the element parts are disposed in a matrix shape so as to be arranged in a plurality of rows and a plurality of columns,
the element parts in the row that is identical each have one of the both electrodes thereof connected to each other,
the element parts in the column that is identical each have another of the both electrodes thereof connected to each other, and
the potential applier includes a switching element configured to switch the row and the column to which the potential is applied.

According to this technology, since the plurality of the element parts are disposed in a matrix shape, distribution of the load in an area spreading in a quadrangular shape can be detected by these element parts. In addition, since the row and the column to which potentials are applied are switched by the switching element, predetermined potentials can be respectively applied to two electrodes of the element part present at the crossing position of the row and the column after the switching, and the capacitance in the element part can be smoothly detected through the above control.

### (Technology 9)

The load detecting device according to technology 8, wherein
the controller
   in the first mode, causes different potentials to be simultaneously applied to both electrodes of all the element parts included in the row serving as a measurement target, and acquires the first value being common between these element parts,
   in the second mode, causes, out of a plurality of the element parts included in the row serving as the measurement target, the element part serving as a measurement target for which a same potential is applied to the both electrodes, to be sequentially switched, and acquires the second value for each of the element parts serving as the measurement target, and
detects capacitance in each of the element parts from the difference between the common first value and the second value in each of the element parts.

According to this technology, the first values are acquired in a batch with respect to the element parts in one row, and thus, the capacitance detection process with respect to each element part can be performed quickly and in a simple manner.

### (Technology 10)

The load detecting device according to technology 8, wherein
the controller
   in the second mode, causes a same potential to be simultaneously applied to both electrodes of all the element parts included in the row serving as a measurement target, and acquires the second value being common between these element parts,
   in the first mode, causes, out of a plurality of the element parts included in the row serving as the measurement target, the element part serving as a measurement target for which different potentials are applied to the both electrodes, to be sequentially switched, and acquires the first value for each of the element parts serving as the measurement target, and
   detects capacitance in each of the element parts from the difference between the first value in each of the element parts and the common second value.

According to this technology, the second values are acquired in a batch with respect to the element parts in one row, and thus, the capacitance detection process with respect to each element part can be performed quickly and in a simple manner.

### (Technology 11)

A detecting circuit configured to detect, from an element part having certain capacitance, the capacitance,
the detecting circuit comprising:
   a potential applier configured to apply a predetermined potential to both electrodes of the element part;
   a measurer configured to measure an electric quantity which changes due to charging or discharging of electric charge with respect to the element part; and
   a controller, wherein
the controller
   acquires a first value from the electric quantity measured in a first mode in which potentials applied to the both electrodes are different from each other,
   acquires a second value from the electric quantity measured in a second mode in which potentials applied to the both electrodes are identical, and
   detects the capacitance in the element part from a difference between the first value and the second value.

According to this technology, effects similar to those in technology 1 can be exhibited.

What is claimed is:

1. A load detecting device comprising:
a load sensor including an element part in which capacitance changes in accordance with a load; and
a detecting circuit configured to detect capacitance in the element part, wherein
the detecting circuit includes
a potential applier configured to apply a predetermined potential to both electrodes of the element part,
a measurer configured to measure an electric quantity which changes due to charging or discharging of electric charge with respect to the element part, and
a controller, and
the controller
acquires a first value from the electric quantity measured in the first mode in which potentials applied to the both electrodes are different from each other,
acquires a second value from the electric quantity measured in a second mode in which potentials applied to the both electrodes are identical, and
detects capacitance in the element part, from a difference between the first value and the second value.

2. The load detecting device according to claim 1, wherein
the measurer measures, as the electric quantity, a current flowing in a charging path in the potential applier.

3. The load detecting device according to claim 1, wherein
the measurer measures, as the electric quantity, a current flowing in a discharging path in the potential applier.

4. The load detecting device according to claim 2, wherein
the controller
acquires, as the first value, an electric charge amount Qm until completion of the charging, from a current Im measured by the measurer in the first mode,
acquires, as the second value, an electric charge amount Qref until completion of the charging, from a current Iref measured by the measurer in the second mode, and
calculates the capacitance in the element part from the electric charge amounts Om, Qref and a potential difference V between the different potentials, by a relational expression below,
$$C = ( Qm - Qref ) / V .$$

5. The load detecting device according to claim 3, wherein
the controller
acquires, as the first value, an electric charge amount Qm until completion of the discharging, from a current Im measured by the measurer in the first mode,
acquires, as the second value, an electric charge amount Qref until completion of the discharging, from a current Iref measured by the measurer in the second mode, and
calculates the capacitance in the element part from the electric charge amounts Om, Qref and a potential difference V between the different potentials, by a relational expression below,
$$C = ( Qm - Qref ) / V .$$

6. The load detecting device according to claim 1, wherein
the measurer measures, as the electric quantity, a voltage in the element part.

7. The load detecting device according to claim 6, wherein
the controller detects the capacitance in the element part, based on temporal change in a difference ΔV between the voltage, which is denoted by Vm, measured by the measurer in the first mode, and the voltage, which is denoted by Vref, measured by the measurer in the second mode.

8. The load detecting device according to claim 1, wherein
the load sensor comprises a plurality of the element parts,
the potential applier is configured to be able to switch the element part to which the potential is applied, and
in the first mode and the second mode, the controller controls the potential applier to apply the potential to each of the element parts, acquires, from the measurer, the electric quantity with respect to each of the element parts, and detects the capacitance with respect to each of the element parts from the first value and the second value based on the acquired electric quantity in each of the element parts.

9. The load detecting device according to claim 8, wherein
the plurality of the element parts are disposed in a matrix shape so as to be arranged in a plurality of rows and a plurality of columns,
the element parts in the row that is identical each have one of the both electrodes thereof connected to each other,
the element parts in the column that is identical each have another of the both electrodes thereof connected to each other, and
the potential applier includes a switching element configured to switch the row and the column to which the potential is applied.

10. The load detecting device according to claim 9, wherein
the controller
in the first mode, causes different potentials to be simultaneously applied to both electrodes of all the element parts included in the row serving as a measurement target, and acquires the first value being common between these element parts,
in the second mode, causes, out of a plurality of the element parts included in the row serving as the measurement target, the element part serving as a measurement target for which a same potential is applied to the both electrodes, to be sequentially switched, and acquires the second value for each of the element parts serving as the measurement target, and
detects capacitance in each of the element parts from the difference between the common first value and the second value in each of the element parts.

11. The load detecting device according to claim 9, wherein
the controller
in the second mode, causes a same potential to be simultaneously applied to both electrodes of all the element parts included in the row serving as a measurement target, and acquires the second value being common between these element parts,
in the first mode, causes, out of a plurality of the element parts included in the row serving as the measurement target, the element part serving as a measurement target for which different potentials are applied to the both electrodes, to be sequentially switched, and acquires the first value for each of the element parts serving as the measurement target, and
detects capacitance in each of the element parts from the difference between the first value in each of the element parts and the common second value.

12. A detecting circuit configured to detect, from an element part having certain capacitance, the capacitance,
the detecting circuit comprising:
a potential applier configured to apply a predetermined potential to both electrodes of the element part;
a measurer configured to measure an electric quantity which changes due to charging or discharging of electric charge with respect to the element part; and
a controller, wherein
the controller
acquires a first value from the electric quantity measured in a first mode in which potentials applied to the both electrodes are different from each other,
acquires a second value from the electric quantity measured in a second mode in which potentials applied to the both electrodes are identical, and
detects the capacitance in the element part from a difference between the first value and the second value.
